(19) United States
(12) Patent Application Publication
(10) Pub. No.: US 2025/0282406 A1
(43) Pub. Date: Sep. 11, 2025

(54) CART

(71) Applicant: MAKITA CORPORATION, Anjo-shi (JP)

(72) Inventors: Shingo KAMINOKADO, Anjo-shi (JP); Ryo UMEMOTO, Anjo-shi (JP); Hirokatsu YAMAMOTO, Anjo-shi (JP); Tadasuke MATSUNO, Anjo-shi (JP); Hiroshi OMONO, Anjo-shi (JP)

(73) Assignee: MAKITA CORPORATION, Anjo-shi (JP)

(21) Appl. No.: 19/060,974

(22) Filed: Feb. 24, 2025

(30) Foreign Application Priority Data
Mar. 11, 2024 (JP) 2024-037412
Mar. 11, 2024 (JP) 2024-037491
Mar. 11, 2024 (JP) 2024-037492

(51) Int. Cl. B62B 5/00; B62B 5/06

(52) U.S. Cl. CPC B62B 5/0069; B62B 5/0063; B62B 5/06

(57) ABSTRACT

A cart may include a body unit, a ground contact unit supported by the body unit, a prime mover configured to drive the ground contact unit, a first UWB anchor including a first antenna and a second antenna and configured to receive a beacon signal from a UWB tag, a second UWB anchor configured to receive the beacon signal from the UWB tag, and a control device configured to execute a following operation of causing the cart to follow the UWB tag by driving the prime mover. The control device may be configured to calculate a first distance which is a distance between the first UWB anchor and the UWB tag and a first tag angle which is an angle of the UWB tag relative to the first UWB anchor by using the beacon signal received by the first antenna and the beacon signal received by the second antenna.

### REFERENCE TO RELATED APPLICATIONS

This application claims priority from Japanese Patent Application No. 2024-37491 filed on Mar. 11, 2024, Japanese Patent Application No. 2024-37492 filed on Mar. 11, 2024, and Japanese Patent Application No. 2024-37412 filed on Mar. 11, 2024. The entire content of the priority application is incorporated herein by reference.

### TECHNICAL FIELD

The art disclosed herein relates to a cart.

### BACKGROUND ART

Japanese Patent Application Publication No. 2023-13129 describes a cart. The cart includes: a body unit; a ground contact unit supported by the body unit and configured to be in contact with a ground; a prime mover configured to drive the ground contact unit; an anchor configured to receive a beacon signal from a tag configured to be carried by a user; and a control device configured to execute a following operation of causing the cart to follow the tag by driving the prime mover.

### SUMMARY

In the cart configured to execute the following operation, precise calculation of a tag position, that is, a position of the user is desired. The present teachings provide an art configured to allow precise calculation of a position of a user.

A cart disclosed herein may comprise: a body unit; a ground contact unit supported by the body unit and configured to be in contact with a ground; a prime mover configured to drive the ground contact unit; a first UWB anchor including a first antenna and a second antenna different from the first antenna and configured to receive a beacon signal from a UWB tag configured to be carried by a user; a second UWB anchor a position of which is different from that of the first UWB anchor in a front-rear direction and configured to receive the beacon signal from the UWB tag; and a control device configured to execute a following operation of causing the cart to follow the UWB tag by driving the prime mover. The control device may be configured to calculate a first distance which is a distance between the first UWB anchor and the UWB tag and a first tag angle which is an angle of the UWB tag relative to the first UWB anchor by using the beacon signal received by the first antenna and the beacon signal received by the second antenna.

According to the above configuration, by using the first UWB anchor and the second UWB anchor with different positions in the front-rear direction, the position of the UWB tag, that is, the position of the user can be calculated with high precision.

### BRIEF DESCRIPTION OF DRAWINGS

FIG. 1 illustrates a perspective view of a cart 2 according to a first embodiment from a right upper front side.

FIG. 2 illustrates a left view of the cart 2 according to the first embodiment.

FIG. 3 illustrates a perspective view of a body unit 4 according to the first embodiment from the right upper front side.

FIG. 4 illustrates a cross-sectional view of a right front overload detection mechanism 26A according to the first embodiment from the right upper front side.

FIG. 5 illustrates a control configuration of the cart 2 according to the first embodiment.

FIG. 6 illustrates a right cross-sectional view of a housing 72 according to the first embodiment.

FIG. 7 illustrates a front view of a front UWB anchor 78 according to the first embodiment.

FIG. 8 illustrates a front cross-sectional view of a central switch box 98 according to the first embodiment.

FIG. 9 illustrates a right cross-sectional view of the central switch box 98 according to the first embodiment.

FIG. 10 illustrates a front view of a rear UWB anchor 108 according to the first embodiment.

FIG. 11 illustrates a flowchart of a following mode process according to the first embodiment.

FIG. 12 illustrates a situation where a UWB tag 200 is located in a following operation permitted area.

FIG. 13 illustrates a transmission path of a beacon signal when the UWB tag 200 is located in a following operation prohibited area.

FIG. 14 illustrates a situation where the UWB tag 200 is located in the following operation prohibited area.

FIG. 15 illustrates a schematic view of a cart 302 according to a reference example 1.

FIG. 16 illustrates a flowchart of a following mode process according to the reference example 1.

FIG. 17 illustrates a schematic diagram indicating a relation between the UWB tag 200 and a radio field intensity in the reference example 1.

FIG. 18 illustrates a schematic diagram of a cart 402 according to a reference example 2.

FIG. 19 illustrates a flowchart of a following mode process according to the reference example 2.

FIG. 20 illustrates a situation where the UWB tag 200 is located to the right of the cart 402 in the reference example 2.

FIG. 21 illustrates a situation where the UWB tag 200 is located to the left of the cart 402 in the reference example 2

FIG. 22 illustrates an overall perspective view of a cart 502 according to a second embodiment.

FIG. 23 illustrates a block diagram depicting a configuration of the cart 502 according to the second embodiment.

FIG. 24 illustrates an overall perspective view of a beacon 582 according to the second embodiment.

FIG. 25 illustrates a circuit diagram depicting an electrical configuration of the beacon 582 according to the second embodiment.

FIG. 26 illustrates a flowchart of processes executed by a microcontroller 602 of the beacon 582 when a main power of the beacon 582 according to the second embodiment is ON.

FIG. 27 illustrates a flowchart of processes executed by a control device 552 of the cart 502 when the main power of the cart 502 according to the second embodiment is ON and also a following mode is selected.

FIG. 28 illustrates a flowchart of a following operation control process executed by the control device 552 of the cart 502 according to the second embodiment.

FIG. 29 illustrates a diagram schematically depicting a first angular range A1, a second angular range A2, and a third angular range A3 as seen from the cart 502 according to the second embodiment.

FIG. 30 illustrates a graph indicating a relation between an offset angle θo and a turning curvature K during the following operation of the cart 502 in the cart 502 according to the second embodiment.

FIG. 31 is a flowchart of a following operation control process executed by a control device 552 of a cart 502 according to a third embodiment.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved carts as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

A cart disclosed herein may comprise: a body unit; a ground contact unit supported by the body unit and configured to be in contact with a ground; a prime mover configured to drive the ground contact unit; a first UWB anchor including a first antenna and a second antenna different from the first antenna and configured to receive a beacon signal from a UWB tag configured to be carried by a user; a second UWB anchor a position of which is different from that of the first UWB anchor in a front-rear direction and configured to receive the beacon signal from the UWB tag; and a control device configured to execute a following operation of causing the cart to follow the UWB tag by driving the prime mover. The control device may be configured to calculate a first distance which is a distance between the first UWB anchor and the UWB tag and a first tag angle which is an angle of the UWB tag relative to the first UWB anchor by using the beacon signal received by the first antenna and the beacon signal received by the second antenna.

In one or more embodiments, the control device may be configured to calculate a second distance which is a distance between the second UWB anchor and the UWB tag by using the beacon signal received by the second UWB anchor. The control device may be configured to assess whether the UWB tag is located in a first area or a second area different from the first area by using the first distance and the second distance.

According to the above configuration, by using the first UWB anchor and the second UWB anchor with different positions in the front-rear direction, whether the user is located in the first area or in the second area can be determined with high precision.

In one or more embodiments, the first UWB anchor may be located frontward of the second UWB anchor. The first antenna and the second antenna may be aligned in a left-right direction. A midpoint between the first antenna and the second antenna in the left-right direction may match a center of the second UWB anchor in the left-right direction. When a second tag angle which is an angle between a first virtual line connecting the first UWB anchor and the UWB tag and a second virtual line connecting the first UWB anchor and the second UWB anchor is an obtuse angle, the control device may determine that the UWB tag is located in the first area. When the second tag angle is 90 degrees or an acute angle, the control device may determine that the UWB tag is located in the second area.

There is a case where an area in which the user is located frontward of the first UWB anchor is the first area and an area in which the user is located directly laterally next to the first UWB anchor or rearward of the first UWB anchor is the second area. When the second tag angle is an obtuse angle, the user is located frontward of the first UWB anchor, and when the second tag angle is 90°, the user is directly laterally next to the first UWB anchor, and when the second tag angle is an acute angle, the user is located rearward of the first UWB anchor. Accordingly, whether the user is located in the first area or in the second area can be determined with high precision.

In one or more embodiments, the first area may be a following operation permitted area in which the following operation is permitted. The second area may be a following operation prohibited area in which the following operation is prohibited.

According to the above configuration, only when the user is located in the following operation permitted area, the cart can be caused to execute the following operation.

In one or more embodiments, when the control device determines that the UWB tag is located in the following operation permitted area, the control device may calculate a target velocity and a target angular velocity by using the first distance and the first tag angle to control the prime mover.

According to the above configuration, when the user is located in the following operation permitted area, the cart can be caused to operate so as to follow the user.

In one or more embodiments, when the control device determines that the UWB tag has moved from the following operation permitted area to the following operation prohibited area, the control device may stop the prime mover. When the control device determines that the UWB tag has moved from the following operation prohibited area to the following operation permitted area, the control device may drive the prime mover.

According to the above configuration, under a situation where the user is located in the following operation prohibited area, the cart can be suppressed from traveling. Accordingly, the cart can be caused to properly execute the following operation.

In one or more embodiments, the first UWB anchor may have a higher receiving sensitivity for signals arriving from a front side than for signals arriving from a rear side.

According to the above configuration, it becomes less likely that the beacon signal sent from a UWB tag located in the following operation prohibited area is received. In this case, when the beacon signal is not received, the control device can determine that the UWB tag is located in the following operation prohibited area. Accordingly, whether the UWB tag is located in the following operation prohibited area or not can be easily determined.

In one or more embodiments, the cart may further comprise a load platform supported by the body unit. One of the first UWB anchor and the second UWB anchor may be a front UWB anchor located frontward of the load platform.

A luggage/cargo, for example, is carried on the load platform. The beacon signal from the UWB tag may be interrupted by the luggage/cargo carried on the load platform, as a result of which the front UWB anchor cannot receive the beacon signal. According to the above configuration, because the beacon signal from the UWB tag is not interrupted by the luggage/cargo carried on the load platform, a possibility of the front UWB anchor receiving the beacon signal can be increased.

In one or more embodiments, the other of the first UWB anchor and the second UWB anchor may be a rear UWB anchor located rearward of the load platform. The rear UWB anchor may be located above the front UWB anchor and the load platform.

The beacon signal may not be received by the rear UWB anchor due to being interrupted by the luggage/cargo carried on the load platform. According to the above configuration, because the beacon signal from the UWB tag is not interrupted by the luggage/cargo carried on the load platform, a possibility of the rear UWB anchor receiving the beacon signal from the UWB tag can be increased.

In one or more embodiments, the cart may further comprise a handle including a grip configured to be grasped by the user. The handle may be located above the load platform. The rear UWB anchor may be disposed in or on the handle.

According to the above configuration, the rear UWB anchor can be easily disposed above the load platform.

Another cart disclosed herein may be configured to execute a following operation of autonomously following a following target. The cart may comprise: a body; a wheel supported by the body and configured to be in contact with a ground; a prime mover configured to drive the wheel; an offset angle detector configured to detect an offset angle of the following target relative to a forward direction of the cart; and a control device. The control device is configured to execute a following operation control process of controlling the following operation of the cart. In the following operation control process, when the offset angle is within a first angular range including 0 degrees, the control device adjusts a turning degree of the cart during the following operation of the cart to a normal turning degree corresponding to the offset angle, and when the offset angle is within a second angular range adjacent to the first angular range, the control device adjusts the turning degree during the following operation of the cart to a reduced turning degree which is reduced from the normal turning degree corresponding to the offset angle.

When an absolute value of the offset angle is greater, a turning angle required to direct the forward direction of the cart toward the following target is greater. Due to this, increasing the turning degree of the cart may be considered. However, if the turning degree of the cart is excessively large, an inner wheel difference of the cart may be excessively enlarged. As a result, the cart may collide with an obstacle, as a result of which the following operation of the cart may not smoothly proceed. According to the above configuration, when the offset angle is within the second angular range (that is, the absolute value of the offset angle is relatively large), the turning degree of the cart is reduced than in normal times. Due to this, the turning degree of the cart can be suppressed from becoming excessively large, by which the inner wheel difference of the cart can be suppressed from being excessively enlarged. Due to this, the cart can be suppressed from contacting an obstacle, by which the following operation of the cart can be smoothly proceeded.

The “turning degree” herein is an index indicating slowness (or rapidness) of a turning motion the cart performs. The “turning degree” can be replaced with for example “a curvature (turning curvature) of a turning radius of the cart” or “a swiveling angle of a steering wheel relative to the forward direction of the cart”.

In one or more embodiments, the turning degree may include a turning curvature of the cart. In the following operation control process, the offset angle is within the first angular range, the control device may adjust the turning curvature during the following operation of the cart to a normal turning curvature corresponding to the offset angle, and when the offset angle is within the second angular range, the control device may adjust the turning curvature during the following operation of the cart to a reduced turning curvature which is reduced from the normal turning curvature corresponding to the offset angle.

According to the above configuration, when the offset angle is within the second angular range (i.e., the absolute value of the offset angle is relatively large), the turning curvature of the cart can be reduced than in normal times. Due to this, the turning curvature of the cart can be suppressed from being excessively increased, by which the inner wheel difference of the cart can be suppressed from being excessively enlarged. Due to this, since the cart can be suppressed from colliding with an obstacle, the following operation of the cart can be smoothly proceeded.

In one or more embodiments, the cart may be configured to switch between a following mode in which execution of the following operation is permitted and a manual mode in which the execution of the following operation is prohibited and the cart moves based on an operation from a user. A minimum turning radius of the cart in the following mode may be greater than a minimum turning radius of the cart in the manual mode.

When the cart has a smaller turning radius, the inner wheel difference of the cart is enlarged. Due to this, when the turning radius of the cart becomes small in the following mode in which the operation by the user does not intervene, the cart may contact an obstacle. In the meantime, in the manual mode in which the operation by the user intervenes, even when the turning radius of the cart becomes small to a certain degree, the possibility of the cart contacting an obstacle is probably low. Rather, if the turning radius of the cart cannot be made small in the manual mode, maneuverability of the cart may be decreased. According to the above configuration, the minimum turning radius of the cart in the following mode is greater than the minimum turning radius of the cart in the manual mode. As a result, the turning radius of the cart can be suppressed from being made small in the following mode, and the turning radius can be permitted to be small in the manual mode. Due to this, the cart can be suppressed from contacting an obstacle without imparting the maneuverability of the cart in the manual mode.

In one or more embodiments, in the following operation control process, when the offset angle is within a third angular range excluding the first angular range and the second angular range, the control device may stop the prime mover to stop the following operation of the cart.

When an absolute value of the offset angle is greater and thus a turning angle required to direct the forward direction of the cart to the following target is greater, the cart would need to be turned greatly. However, if the cart is turned greatly, the cart may contact an obstacle, by which the following operation of the cart may not proceed smoothly. According to the above configuration, when the offset angle is within the third angular range (i.e., the absolute value of the offset angle is relatively large), the following operation by the cart is stopped. Due to this, the cart can be suppressed from turning greatly. As a result, the cart can be suppressed from contacting the obstacle, the following operation of the cart can be smoothly proceeded.

Yet another cart disclosed herein may be configured to execute a following operation of autonomously following a following target. The cart may comprise: a body; a wheel supported by the body and configured to be in contact with a ground; a prime mover configured to drive the wheel; an offset angle detector configured to detect an offset angle of the following target relative to a forward direction of the cart; and a control device. The control device may be configured to operate the prime mover to cause the cart to execute the following operation when the offset angle is within an operation angular range including 0 degrees, and when the offset angle is within a stop angular range adjacent to the operation angular range, the control device may be configured to stop the prime mover to stop the following operation by the cart.

When an absolute value of the offset angle is greater and thus a turning angle required to direct the forward direction of the cart toward the following target is greater, the cart would need to be turned greatly. However, if the cart is turned greatly, the cart may contact an obstacle, by which the following operation of the cart may not proceed smoothly. According to the above configuration, when the offset angle is within the operation angular range (i.e., the absolute value of the offset angle is relatively small), the following operation by the cart is executed. When the offset angle is within the stop angular range (i.e., the absolute value of the offset angle is relatively large), the following operation by the cart is stopped. Due to this, the cart can be suppressed from turning greatly. As a result, the cart can be suppressed from contacting the obstacle, the following operation of the cart can be smoothly proceeded.

The present teachings further disclose a transport system. The transport system may comprise: a cart; and a communication terminal configured to communicate with the cart. The cart may be configured to execute a following operation of following the communication terminal when the communication terminal is moving. The communication terminal may comprise: a first operation part; and a second operation part located at a position different from the first operation part. When the first operation part is operated, the communication terminal may switch power of the communication terminal between ON and OFF. When the second operation part is operated during a predetermined start-operation receiving period with the power ON, the communication terminal may send a following start instruction which instructs to start the following operation to the cart.

According to the above configuration, the communication terminal includes the second operation part for causing the cart to start the following operation at the position different from the first operation part. Even if the first operation part is operated without user's intention, unless the second operation part is operated thereafter, the following operation by the cart is not started. Due to this, the following operation by the cart can be suppressed from being started without user's intension.

In one or more embodiments, the communication terminal may further comprise a third operation part disposed at a position different from those of the first operation part and the second operation part. When the third operation part is operated during a predetermined stop operation receiving period with the power ON, the communication terminal may send a following stop instruction which instructs to stop the following operation to the cart.

It is also conceivable to provide the communication terminal with a switching operation part configured to receive switching between starting and stopping of the following operation. In this configuration however, when the user operates the switching operation part, whether the communication terminal instructs the cart to start or stop the following operation may become unclear for the user. According to the above configuration, the operation part (second operation part) for receiving the start of the following operation and the operation part (third operation part) for receiving the stop of the following operation are disposed separate from each other. Due to this, when the user operates the second operation part/third operation part, whether the communication terminal instructs the cart to start/stop the following operation is clarified for the user.

In one or more embodiments, when the third operation part is operated during the stop operation receiving period with the power ON, the communication terminal may continuously send the following stop instruction to the cart until a predetermined send finish condition is satisfied.

For example, if communication connection is not good between the cart and the communication terminal, the following stop instruction sent from the communication terminal may not be received at the cart. If the communication terminal stops sending the following stop instruction despite the cart has not received the following stop instruction, the following operation by the cart would not be stopped, and thus would undesirably continue thereafter. In this configuration, a situation in which the user has operated the third operation part but the following operation by the cart is not stopped at all may happen. According to the above configuration, after the third operation part is operated, the communication terminal continuously sends the following stop instruction until the send finish condition is satisfied. Due to this, the situation in which the user has operated the third operation part but the following operation by the cart is not stopped at all can be suppressed.

In one or more embodiments, the send finish condition may include a first send finish condition that the second operation part is operated.

According to the above configuration, the communication terminal continuously sends the following stop instruction from when the third operation part is operated until the second operation part is operated next. Due to this, the situation in which the user has operated the third operation part but the following operation by the cart is not stopped at all can be suppressed.

In one or more embodiments, the cart may be configured to switch between a following mode in which execution of the following operation is permitted and a manual mode in which the execution of the following operation is prohibited and the cart moves based on an operation from the user. The start-operation receiving period may be at least a period during which the cart is in the following mode.

If a period during which the cart is in the manual mode is the start-operation receiving period, when the second operation part is operated during the manual mode, the following operation by the cart may undesirably start at a timing when the cart is switched to the following mode. Due to this, the following operation by the cart may undesirably start a while late after the user has operated the second operation part. This means that the following operation by the cart starts at an unexpected timing for the user. According to the above configuration, the start-operation receiving period is at least a period during which the cart is in the following mode. Due to this, even if the second operation part is operated during the manual mode, since that operation is not accepted, the following operation by the cart is not to be started thereafter. Due to this, the following operation by the cart can be suppressed from being started at an unexpected timing for the user.

In one or more embodiments, the start-operation receiving period may be at least a period during which communication between the cart and the communication terminal is established.

If a period during which the communication between the cart and the communication terminal is lost is the start-operation receiving period, when the second operation part is operated during such period, the following operation by the cart may undesirably start at a timing when the communication is established thereafter. Due to this, the following operation by the cart may undesirably start a while late after the user has operated the second operation part. This means that the following operation by the cart starts at an unexpected timing for the user. According to the above configuration, the start-operation receiving period is at least a period during which the communication between the cart and the communication terminal is established. Due to this, even if the second operation part is operated during the period when the communication between the cart and the communication terminal is lost, since that operation is not accepted, the following operation by the cart is not to be started thereafter. Due to this, the following operation by the cart can be suppressed from being started at an unexpected timing for the user.

In one or more embodiments, the communication terminal may send a following stop instruction which instructs the cart to stop the following operation to the cart immediately after the power is turned ON.

According to the above configuration, the following operation by the cart is stopped immediately after the power of the communication terminal is turned ON. Due to this, for the first time after the second operation part is operated after the power of the communication terminal is turned ON, the following operation by the cart is started. Due to this, the following operation by the cart can be suppressed from being started without a user's intention.

The present teachings further disclose an electric apparatus. The electric apparatus may comprise: a microcontroller; a battery interface configured to be electrically connected to a battery; a first switch circuit configured to permit power supply to the microcontroller when the first switch circuit is ON and configured to prohibit power supply to the microcontroller when the first switch circuit is OFF; and a second switch circuit configured to permit power discharge from the battery when the second switch circuit is ON and prohibit power discharge from the battery when the second switch circuit is OFF.

When the electric apparatus is left unused for a long period of time with the battery attached to the battery interface, a remaining level of the battery may decrease due to natural discharge of electricity (natural power discharge). According to the above configuration, the second switch circuit configured to switch between permission/prohibition on the power discharge from the battery is provided separately from the first switch circuit configured to switch permission/prohibition on the power supply to the microcontroller (i.e., ON/OFF of power). In this configuration, by having the second switch circuit OFF, the natural power discharge from the battery can be suppressed. Due to this, by having the second switch circuit OFF when the electrical apparatus is left unused for a long period of time, the decrease in the remaining level of the battery can be suppressed.

In one or more embodiments, the second switch circuit and the first switch circuit may be arranged in series on a power supply path from the battery interface to the microcontroller.

According to the above configuration, by having the second switch circuit OFF, irrespective of the ON/OFF state of the first switch circuit, the power supply to the microcontroller can be prohibited.

In one or more embodiments, the first switch circuit may be an electrical switch. The second switch circuit may be an electrical switch.

According to the above configuration, as compared to when the first switch circuit (second switch circuit) is for example a mechanical switch, the first switch circuit (second switch circuit) can be made smaller.

In one or more embodiments, the electrical apparatus may further comprise a USB port configured to receive a USB cable. The second switch circuit may be switched from OFF to ON when the electrical apparatus is supplied with power from the USB cable via the USB port.

According to the above configuration, with a relatively simple operation of connecting the USB cable to the USB port, the second switch circuit can be switched from OFF to ON.

In one or more embodiments, the battery may be a rechargeable secondary battery.

When the battery is a secondary battery, the battery may be sometimes configured difficult to be removed from the electrical apparatus. Due to this, the battery is stored in the state attached to the electrical apparatus, and natural power discharge from the battery may occur while the electrical apparatus is stored. In order to address this situation, according to the above configuration, by having the second switch circuit OFF while the electrical apparatus is stored, the natural power discharge from the battery can be suppressed.

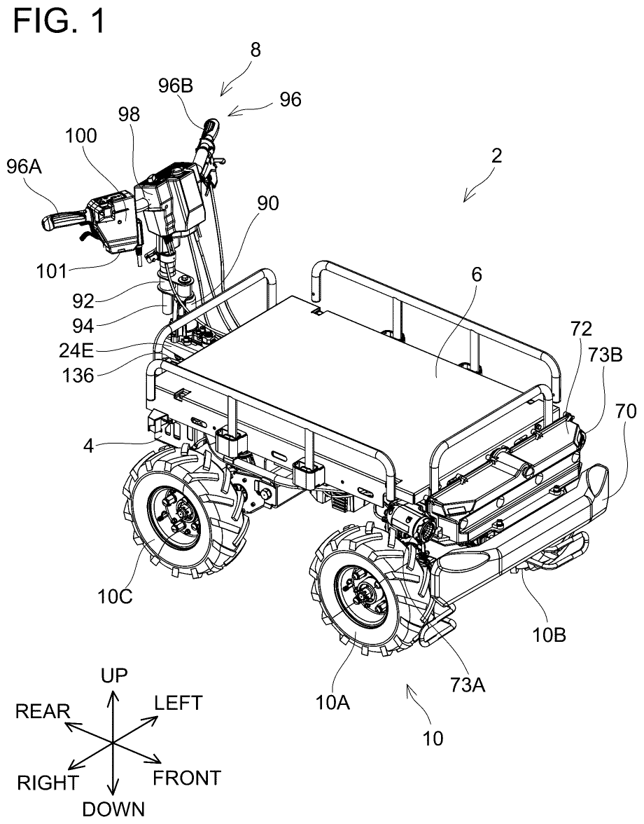

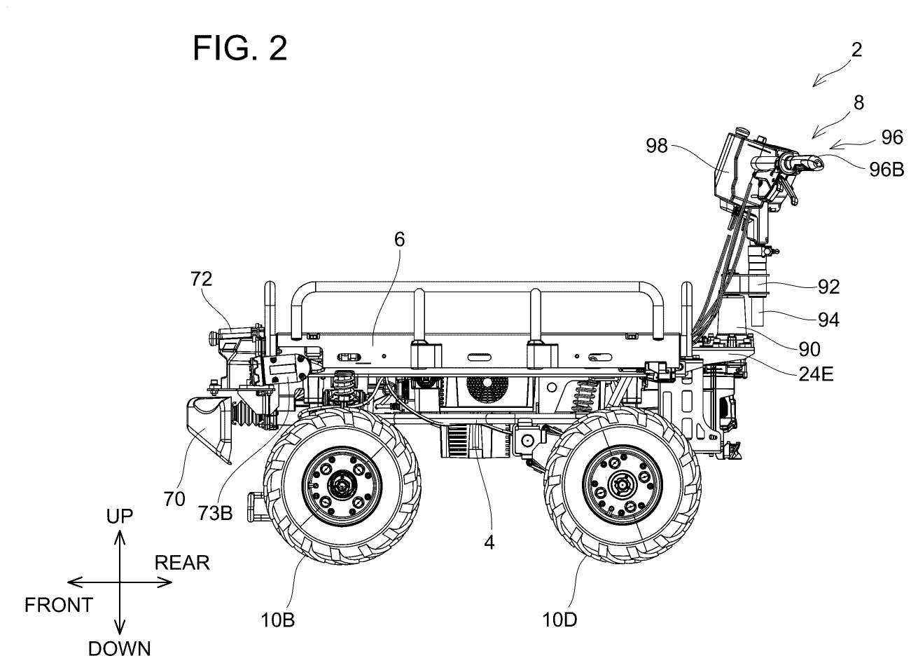

(First Embodiment) A cart 2 illustrated in FIG. 1 comprises a body unit 4, a load platform 6, a handle unit 8, and wheels 10. The wheels 10 comprise a right front wheel 10A, a left front wheel 10B, a right rear wheel 10C, and a left rear wheel 10D (see FIG. 2). The load platform 6, the handle unit 8, the right front wheel 10A, the left front wheel 10B, the right rear wheel 10C, and the left rear wheel 10D are all supported by the body unit 4.

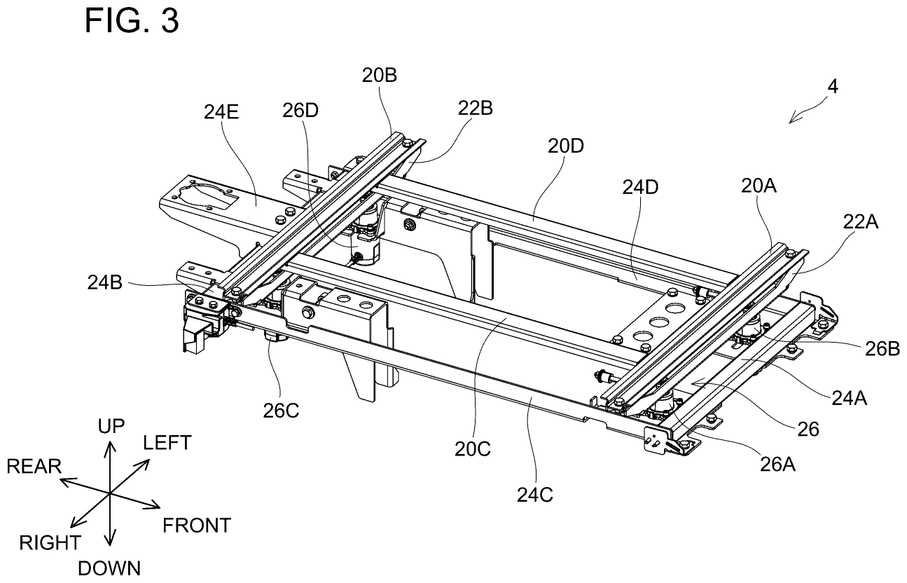

As illustrated in FIG. 3, the body unit 4 comprises a first front frame 20A, a first rear frame 20B, a right frame 20C, a left frame 20D, a second front frame 22A, and a second rear frame 22B. The first front frame 20A, the first rear frame 20B, the second front frame 22A, and the second rear frame 22B all extend in a left-right direction. The second front frame 22A is fixed to the first front frame 20A from below at opposing ends of the second front frame 22A in the left-right direction. The second rear frame 22B is fixed to the first rear frame 20B from below at opposing ends of the second rear frame 22B in the left-right direction. The right frame 20C and the left frame 20D extend in a front-rear direction. The right frame 20C and the left frame 20D connect the first front frame 20A and the first rear frame 20B. The right frame 20C is arranged to the right of a center of the first front frame 20A in the left-right direction. The left frame 20D is arranged to the left of the center of the first front frame 20A in the left-right direction.

The body unit 4 further comprises a front auxiliary frame 24A, a rear auxiliary frame 24B, a right auxiliary frame 24C, a left auxiliary frame 24D, a handle support plate 24E, and an overload detection mechanism 26. The overload detection mechanism 26 comprises a right front overload detection mechanism 26A, a left front overload detection mechanism 26B, a right rear overload detection mechanism 26C, and a left rear overload detection mechanism 26D.

The front auxiliary frame 24A, the rear auxiliary frame 24B, the right auxiliary frame 24C, and the left auxiliary frame 24D are disposed below the second front frame 22A and the second rear frame 22B. The front auxiliary frame 24A and the rear auxiliary frame 24B extend in the left-right direction. The right auxiliary frame 24C and the left auxiliary frame 24D extend in the front-rear direction. The right auxiliary frame 24C connects a right end of the front auxiliary frame 24A and a right end of the rear auxiliary frame 24B. A front portion of the right auxiliary frame 24C is attached to the second front frame 22A via the right front overload detection mechanism 26A. A rear portion of the right auxiliary frame 24C is attached to the second rear frame 22B via the right rear overload detection mechanism 26C. The left auxiliary frame 24D connects a left end of the front auxiliary frame 24A and a left end of the rear auxiliary frame 24B. A front portion of the left auxiliary frame 24D is attached to the second front frame 22A via the left front overload detection mechanism 26B. A rear portion of the left auxiliary frame 24D is attached to the second rear frame 22B via the left rear overload detection mechanism 26D.

The right front overload detection mechanism 26A, the left front overload detection mechanism 26B, the right rear overload detection mechanism 26C and the left rear overload detection mechanism 26D all have a same configuration. Hereafter, the right front overload detection mechanism 26A only will be described, and descriptions for the left front overload detection mechanism 26B, the right rear overload detection mechanism 26C, and the left rear overload detection mechanism 26D will be omitted.

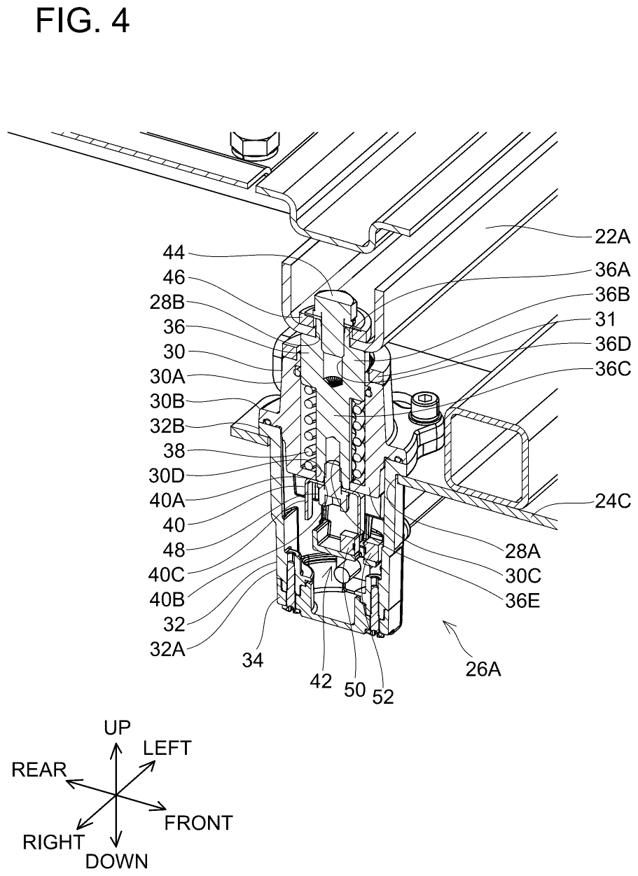

As illustrated in FIG. 4, the right front overload detection mechanism 26A comprises a base part 30, a buffer member 31, a housing part 32, a cap part 34, a shaft 36, a coil spring 38, a detection plate 40, and a detection sensor 42.

The base part 30 comprises a first cylindrical part 30A, a first flange part 30B extending outward from an outer peripheral surface of the first cylindrical part 30A, and an inner projection part 30C extending inward from an inner peripheral surface of a lower end of the first cylindrical part 30A. Existence of the inner projection part 30C defines a first hole 30D having a smaller diameter than an inner diameter of the first cylindrical part 30A. The buffer member 31 is attached to an upper portion of the base part 30.

The housing part 32 comprises a second cylindrical part 32A and a second flange part 32B extending outward from an outer peripheral surface of an upper end of the second cylindrical part 32A. An inner diameter of an upper portion of the second cylindrical part 32A is greater than an outer diameter of the first cylindrical part 30A of the base part 30. A first frame hole 28A is defined in the front portion of the right auxiliary frame 24C. An outer diameter of the second cylindrical part 32A is smaller than a diameter of the first frame hole 28A. The second cylindrical part 32A penetrates the first frame hole 28A in an up-down direction. A diameter of the second flange part 32B is the same as a diameter of the first flange part 30B of the base part 30. The diameter of the second flange part 32B is greater than a diameter of the first frame hole 28A. A lower surface of the first flange part 30B abuts an upper surface of the second flange part 32B. An upper surface of the right auxiliary frame 24C abuts a lower surface of the second flange part 32B. The cap part 34 is screwed from below to the second cylindrical part 32A.

The shaft 36 comprises a first shaft part 36A, a second shaft part 36B extending downward from a lower end of the first shaft part 36A, and a third shaft part 36C extending downward from a lower end of the second shaft part 36B. A second frame hole 28B is defined in a right end of the second front frame 22A. The first shaft part 36A penetrates the second frame hole 28B in the up-down direction. A diameter of the second shaft part 36B is greater than a diameter of the first shaft part 36A. The second shaft part 36B is configured to slide inside the first cylindrical part 30A of the base part 30 in the up-down direction. A diameter of the third shaft part 36C is smaller than the diameter of the second shaft part 36B. An upper bolt hole 36D is defined in an upper portion of the shaft 36, and a lower bolt hole 36E is defined in a lower portion of the shaft 36. A first bolt 44 to which a spacer 46 is attached is screwed into the upper bolt hole 36D. A second bolt 48 is screwed into the lower bolt hole 36E via the detection plate 40. The coil spring 38 is disposed between the third shaft part 36C and the first cylindrical part 30A of the base part 30. An upper end of the coil spring 38 abuts a lower surface of the second shaft part 36B, and a lower end of the coil spring 38 abuts an upper surface of the inner projection part 30C of the base part 30.

The detection plate 40 comprises a disk part 40A having a second hole 40B at its center and a detector part 40C. The detector part 40C extends downward from opposing ends of the disk part 40A in the front-rear direction. The disk part 40A is disposed between the second bolt 48 and the third shaft part 36C of the shaft 36 in the up-down direction. The second bolt 48 secures the detection plate 40 to the shaft 36. That is, the shaft 36 and the detection plate 40 move as a unit.

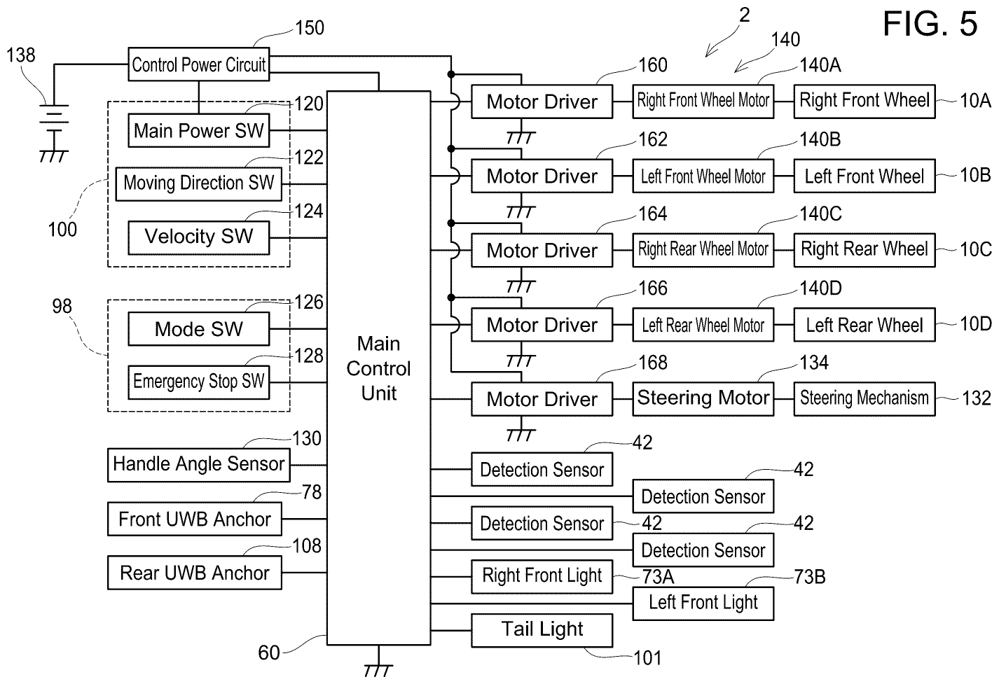

The detection sensor 42 is a so-called photo interrupter. The detection sensor 42 comprises a light emitting element 50 and a light receiving element 52 disposed to face each other. The detection sensor 42 is off when there is no interruption between the light emitting element 50 and the light receiving element 52, and is on when there is an interruption between the light emitting element 50 and the light receiving element 52. The detection sensor 42 is electrically connected to a main control device 60 (see FIG. 5). The main control device 60 of FIG. 5 applies a pulsing voltage to the light emitting element 50. Specifically, the main control device 60 switches between a state of applying a voltage to the light emitting element 50 and a state of not applying the voltage to the light emitting element 50 at predetermined cycles. Due to this, the light emitting element 50 intermittently emits light, i.e., blinks.

As illustrated in FIG. 4, in a state where there is no load on the load platform 6 and thus no load from the load platform 6 is applied on the shaft 36, due to biasing force of the coil spring 38, an upper surface of the disk part 40A of the detection plate 40 abuts a lower surface of the inner projection part 30C of the base part 30. In this state, the detector part 40C of the detection plate 40 does not intervene between the light emitting element 50 and the light receiving element 52. Due to this, the light receiving element 52 receives the intermittent light from the light emitting element 50. In this case, the detection sensor 42 sends an on signal and an off signal at the predetermined cycles. Thus, when the main control device 60 of FIG. 5 receives the on signal and the off signal at the predetermined cycles from the detection sensor 42, the main control device 60 determines that there is no overload.

When, starting from the state illustrated in FIG. 4, a luggage/cargo is carried on the load platform 6 and thus a load from the load platform 6 is applied on the second front frame 22A, the shaft 36 and the detection plate 40 move downward relative to the base part 30 against the biasing force of the coil spring 38. At this occasion, when a load of a predetermined upper limit load or more is applied on the shaft 36, the detector part 40C of the detection plate 40 is positioned between the light emitting element 50 and the light receiving element 52. Due to this, the detector part 40C intervenes the light from the light emitting element 50. Thus, the light receiving element 52 does not receive light. In this case, the detection sensor 42 continuously sends the off signal to the main control device 60 (see FIG. 5). Also, when a power wiring connected to the light emitting element 50 is disconnected, the light emitting element 50 does not emit light, and the light receiving element 52 does not receive the light. In this case also, the detection sensor 42 continuously sends the off signal to the main control device 60 (see FIG. 5). Due to this, when the main control device 60 of FIG. 5 receives the off signal from the detection sensor 42, the main control device 60 determines that an overload is occurring or the power wiring is disconnected.

Further, if a connector connected to the light emitting element 50 of FIG. 4 is experiencing a short circuit, the light emitting element 50 emits continuous light instead of the intermittent light. In this case, the light receiving element 52 receives the continuous light from the light emitting element 50 and the detection sensor 42 continuously sends the on signal to the main control device 60 (see FIG. 5). When the main control device 60 of FIG. 5 continuously receives the on signal from the detection sensor 42, the main control device 60 determines that the connector for example is experiencing a short circuit.

As an assumption, a case where the light emitting element 50 is emitting continuous light in a normal state where disconnection and/or short circuit are not taking place will be described. In this case, the light emitting element 50 emits the continuous light when there is no overload and when a short circuit is taking place. Due to this, when the main control device 60 receives the on signal continuously from the detection sensor 42, the main control device 60 cannot differentiate which situation is occurring, i.e., there is no overload or a short circuit is taking place. According to the above configuration, the main control device 60 is able to accurately distinguish when there is no overload, when there is overload, or when some sort of abnormality is taking place.

As illustrated in FIG. 1, the cart 2 further comprises a bumper 70, a housing 72, a right front light 73A, and a left front light 73B all attached to a front portion of the body unit 4. As illustrated in FIG. 2, the bumper 70 and the housing 72 are disposed in front of the load platform 6. The housing 72 is disposed above the bumper 70. A front end of the housing 72 is disposed rearward of a front end of the bumper 70. The right front light 73A is disposed on the right side of the bumper 70. The left front light 73B is disposed on the left side of the bumper 70.

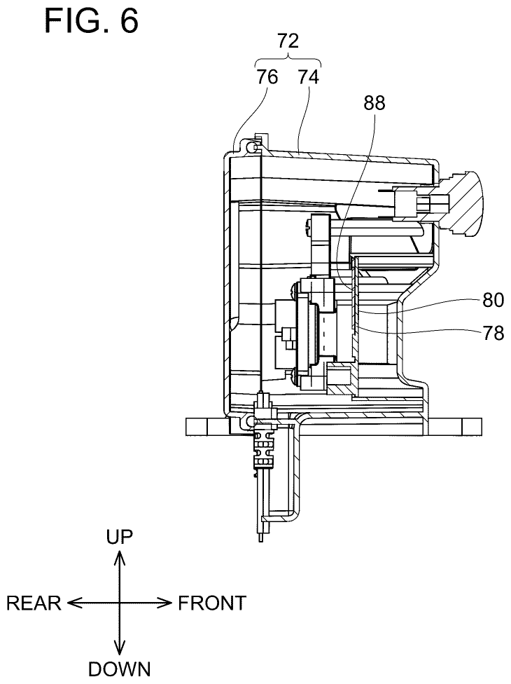

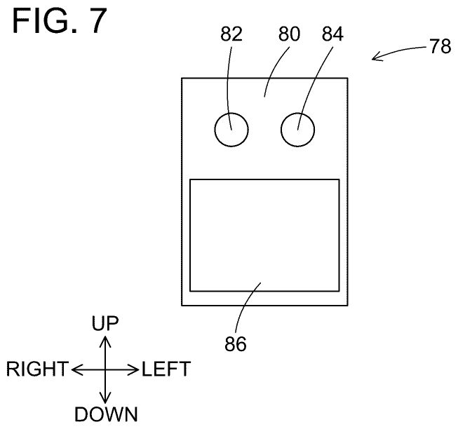

As illustrated in FIG. 6, the housing 72 is composed of a first front housing 74 and a first rear housing 76 fixed to the first front housing 74. The housing 72 accommodates a front UWB anchor 78 therein. The front UWB anchor 78 conforms to a UWB (Ultra Wide Band) standard. In the left-right direction, a center of the front UWB anchor 78 in the left-right direction matches a position of the cart 2. As illustrated in FIG. 7, the front UWB anchor 78 comprises a UWB substrate 80, a first antenna 82, a second antenna 84, an anchor control device 86, and a shield 88 (see FIG. 6). The first antenna 82, the second antenna 84, and the anchor control device 86 are disposed on a front surface of the UWB substrate 80. The first antenna 82 and the second antenna 84 are disposed above the anchor control device 86. The first antenna 82 and the second antenna 84 are aligned in the left-right direction. A midpoint between the first antenna 82 and the second antenna 84 in the left-right direction matches a center of the cart 2 and a center of the front UWB anchor 78. The first antenna 82 is disposed to the right of the center of the UWB substrate 80 in the left-right direction. The second antenna 84 is disposed to the left of the center of the UWB substrate 80 in the left-right direction. As illustrated in FIG. 6, the shield 88 is disposed on a rear surface of the UWB substrate 80. The shield 88 is a member configured to shield a signal transported from a rear side of the front UWB anchor 78. The shield 88 makes a receiving sensitivity for signals arriving from a front side of the front UWB anchor 78 smaller than for signals arriving from the rear side of the front UWB anchor 78.

As illustrated in FIG. 1, the handle unit 8 comprises a fixing shaft 90, a coupling member 92, a support shaft 94, a handle part 96, a central switch box 98, and a right switch box 100. The fixing shaft 90 is fixed to the handle support plate 24E of the body unit 4, and extends upward from the handle support plate 24E. The support shaft 94 extends in the up-down direction. The support shaft 94 is disposed rearward of the fixing shaft 90. The support shaft 94 is pivotably coupled to the fixing shaft 90 via the coupling member 92.

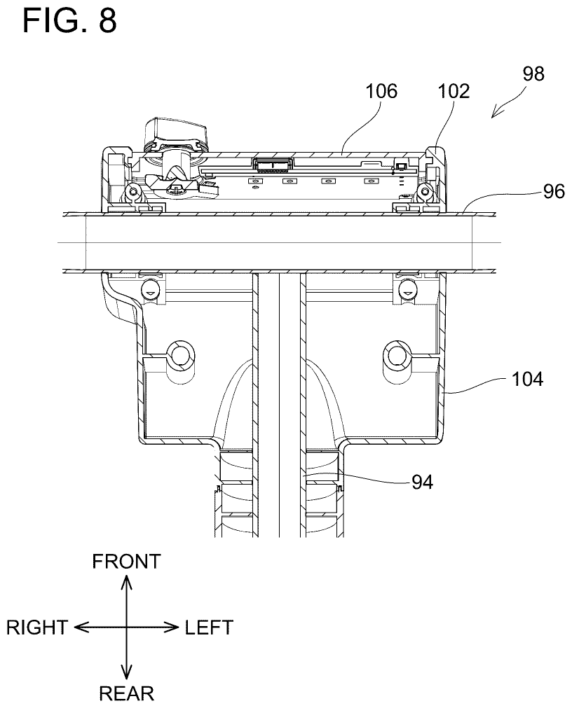

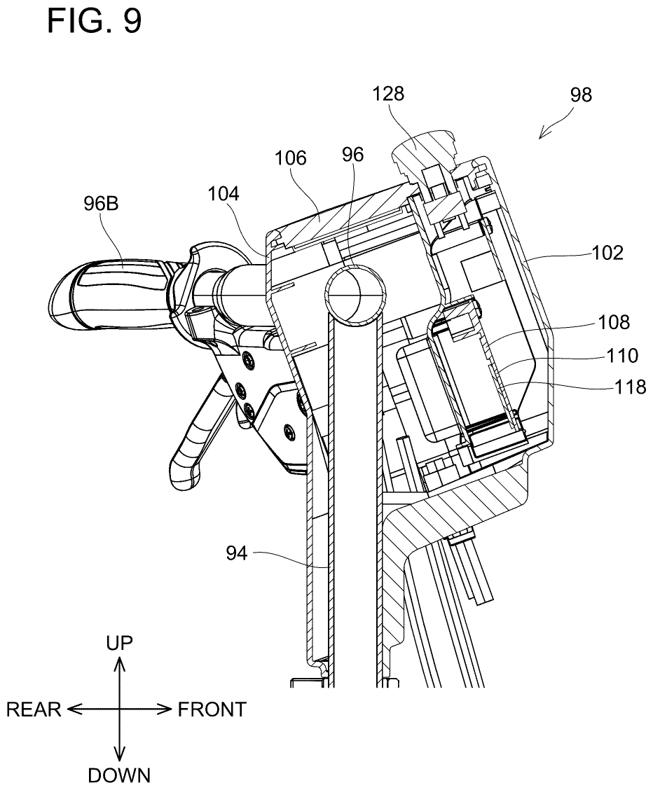

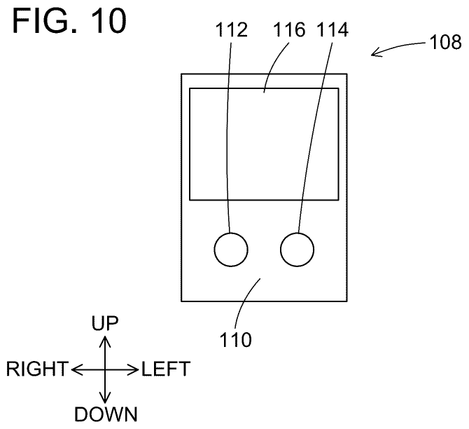

As illustrated in FIG. 8, the handle part 96 is attached to an upper end of the support shaft 94. As illustrated in FIG. 1, the handle part 96 comprises a right grip 96A and a left grip 96B. The central switch box 98 is arranged at a center portion of the handle part 96 in the left-right direction. As illustrated in FIG. 9, the central switch box 98 is composed of a second front housing 102, a second rear housing 104 fixed to the second front housing 102, and an upper plate 106 sandwiched between the second front housing 102 and the second rear housing 104. The central switch box 98 accommodates the rear UWB anchor 108. The rear UWB anchor 108 conforms to the UWB standard. That is, the center of the rear UWB anchor 108 in the left-right direction matches the center of the front UWB anchor 78 (see FIG. 3) in the left-right direction. As illustrated in FIG. 10, the rear UWB anchor 108 comprises a UWB substrate 110, a third antenna 112, a fourth antenna 114, an anchor control device 116, and a shield 118 (see FIG. 9). The third antenna 112, the fourth antenna 114, and the anchor control device 116 are disposed on a front surface of the UWB substrate 110. The third antenna 112 and the fourth antenna 114 are disposed below the anchor control device 116. The third antenna 112 and the fourth antenna 114 are aligned in the left-right direction. A midpoint between the third antenna 112 and the fourth antenna 114 in the left-right direction matches the center of the cart 2 and a center of the rear UWB anchor 108. The third antenna 112 is disposed to the right of a center of the UWB substrate 110 in the left-right direction. The fourth antenna 114 is disposed to the left of the center of the UWB substrate 110 in the left-right direction. As illustrated in FIG. 9, the shield 118 is disposed on a rear surface of the UWB substrate 110. The shield 118 is a member configured to shield a signal transported from the rear side of the rear UWB anchor 108. The shield 118 makes a receiving sensitivity for signals arriving from the front side of the rear UWB anchor 108 smaller than a receiving sensitivity for signals arriving from the rear side of the front UWB anchor 78. As illustrated in FIG. 2, the central switch box 98 is disposed above the housing 72 and the load platform 6. That is, the rear UWB anchor 108 inside the central switch box 98 is disposed above the front UWB anchor 78 in the housing 72 and the load platform 6.

As illustrated in FIG. 1, the right switch box 100 is disposed between the right grip 96A and the central switch box 98. A tail light 101 is disposed at a lower portion of the right switch box 100. As illustrated in FIG. 5, the right switch box 100 further comprises a main power switch 120, a moving direction switch 122, and a speed switch 124. The main power switch 120 is configured to switch on/off of a main power of the cart 2. The moving direction switch 122 is configured to switch a moving direction of the cart 2 in the manual mode. The speed switch 124 is configured to switch a moving speed of the cart 2 in the manual mode. The central switch box 98 includes a mode switch 126 and an emergency stop switch 128. The mode switch 126 is configured to switch an operation mode of the cart 2 between the manual mode, a following mode, and a parking mode. The emergency stop switch 128 is configured to stop traveling of the cart 2.

The user can operate to pivot the handle unit 8 while the user is grasping the right grip 96A and the left grip 96B of the handle unit 8 in FIG. 1 with his/her both hands. As illustrated in FIG. 5, the cart 2 comprises a handle angle sensor 130 configured to detect a pivoting angle of the handle unit 8 as a handle angle, a steering mechanism 132 configured to steer the right front wheel 10A and the left front wheel 10B as steering wheels, and a steering motor 134 configured to drive the steering mechanism 132. The steering motor 134 is for example a brushless motor. The handle angle sensor 130, the steering mechanism 132, and the steering motor 134 are supported by the body unit 4 (see FIG. 1).

As illustrated in FIG. 1, the cart 2 comprises a battery receptacle part 136 arranged on the body unit 4. The battery receptacle part 136 is configured to have a battery pack 138 (see FIG. 5) detachably attached thereto. The battery pack 138 comprises for example secondary battery cell(s) (not illustrated) such as lithium-ion battery cell(s), and is rechargeable by using a charger (not illustrated). The cart 2 operates on power supplied from the battery pack 138 attached to the battery receptacle part 136.

As illustrated in FIG. 5, the cart 2 comprises a traction motor 140. The traction motor 140 comprises a right front wheel motor 140A configured to drive the right front wheel 10A, a left front wheel motor 140B configured to drive the left front wheel 10B, a right rear wheel motor 140C configured to drive the right rear wheel 10C, and a left rear wheel motor 140D configured to drive the left rear wheel 10D. The right front wheel motor 140A, the left front wheel motor 140B, the right rear wheel motor 140C, and the left rear wheel motor 140D are for example brushless motors. The right front wheel motor 140A, the left front wheel motor 140B, the right rear wheel motor 140C, and the left rear wheel motor 140D are supported by the body unit 4 (see FIG. 1).

The cart 2 further comprises a control power circuit 150. The control power circuit 150 is configured to permit supply of power from the battery pack 138 when an on operation is performed on the main power switch 120, and prohibit the supply of power from the battery pack 138 when an off operation is performed on the main power switch 120. The main control device 60 controls operation of the cart 2. The main control device 60 controls operations of the right front wheel motor 140A, the left front wheel motor 140B, the right rear wheel motor 140C, the left rear wheel motor 140D, and the steering motor 134 via motor drivers 160, 162, 164, 166, and 168. Although this is not illustrated, a brake circuit is connected to the motor drivers 160, 162, 164, and 166 corresponding to the right front wheel motor 140A, the left front wheel motor 140B, the right rear wheel motor 140C, and the left rear wheel motor 140D. The main control device 60 can exert great braking force on the right front wheel motor 140A, the left front wheel motor 140B, the right rear wheel motor 140C, and the left rear wheel motor 140D by applying great current to the break circuit while the right front wheel motor 140A, the left front wheel motor 140B, the right rear wheel motor 140C, and the left rear wheel motor 140D are rotating. The control power circuit 150, the main control device 60, the motor drivers 160, 162, 164, 166, and 168, and the break circuit are supported by the body unit 4 (see FIG. 1).

Further, the four detection sensors 42, the front UWB anchor 78, and the rear UWB anchor 108 are electrically connected to the main control device 60.

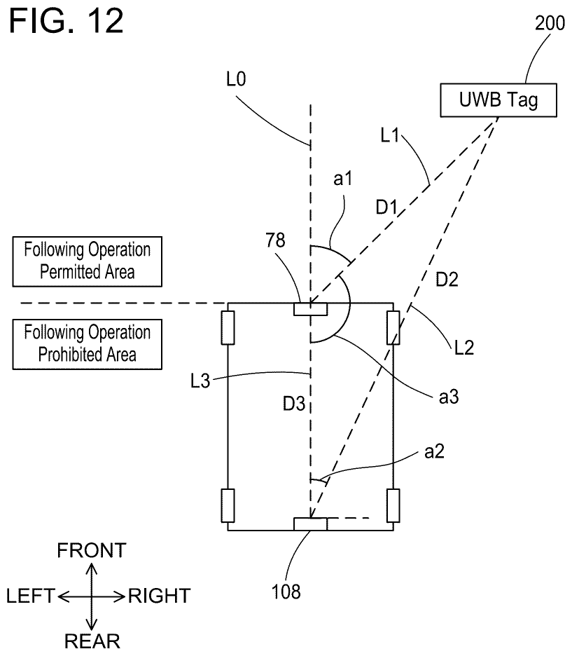

The cart 2 of FIG. 1 is configured to operate in the manual mode, the following mode, or the parking mode. In the manual mode, the cart 2 moves frontward or rearward according to a user's operation with the user standing behind the body unit 4 grasping the handle unit 8 with his/her hands. In the following mode, the cart 2 moves following the UWB tag 200 (see FIG. 12) the user standing in front of the body unit 4 is carrying. In the parking mode, the cart 2 continues to remain stopped without receiving a command from the handle unit 8 or a command from the UWB tag 200. Here, the main control device 60 of the cart 2 is configured to prohibit the cart 2 from traveling when the main control device 60 determines that an overload is occurring or some sort of abnormality is occurring in the cart 2 based on the information received from the detection sensor(s) 42. That is, the traveling of the cart 2 in the manual mode or the following mode is prohibited. Further, the cart 2 is put on emergency stop when the emergency stop switch 128 (see FIG. 5) is operated.

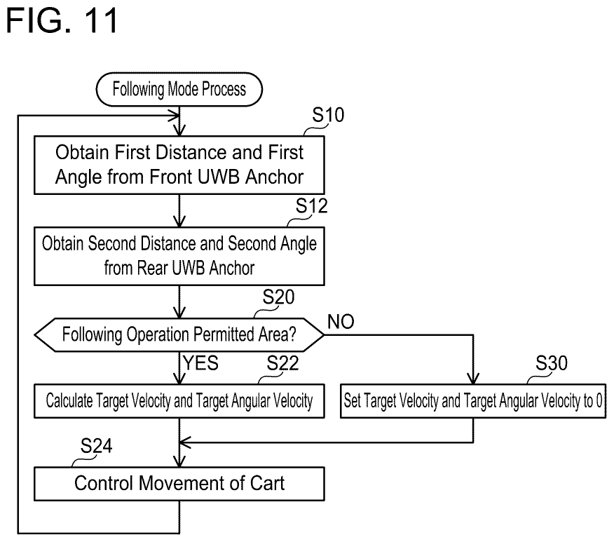

(Following Mode Process; FIG. 11) With reference to FIG. 11, a following mode process executed by the main control device 60 will be described. The main control device 60 starts processes of FIG. 11 when the operation mode of the cart 2 is set to the following mode.

As illustrated in FIG. 12, when the front UWB anchor 78 receives a beacon signal sent from the UWB tag 200 via the first antenna 82 and the second antenna 84 (see FIG. 7), the front UWB anchor 78 calculates a distance from the front UWB anchor 78 to the UWB tag 200 (hereafter, “first distance D1”) and an angle of the UWB tag 200 relative to the front UWB anchor 78 (hereafter, “first angle a1”). The first angle a1 is an angle between a line L0 extending in the front-rear direction and a first line L1 connecting the front UWB anchor 78 and the UWB tag 200. Specifically, the front UWB anchor 78 specifies the first distance D1 by using a transmission time of the beacon signal received via the first antenna 82 and calculates the first angle a1 by using a phase difference between the beacon signal received via the first antenna 82 and the beacon signal received via the second antenna 84. As a method of calculating an angle by using a phase difference, Phase Differences of Arrival (PDoA), Angle of Arrival (AoA) are known, for example.

When the rear UWB anchor 108 receives the beacon signal sent from the UWB tag 200 via the third antenna 112 and the fourth antenna 114 (see FIG. 10), the rear UWB anchor 108 calculates a distance from the rear UWB anchor 108 to the UWB tag 200 (hereafter, “second distance D2”) and an angle of the UWB tag 200 relative to the rear UWB anchor 108 (hereafter, “second angle a2”). The second angle a2 is an angle between the line L0 extending in the front-rear direction and a second line L2 connecting the rear UWB anchor 108 and the UWB tag 200. Calculation methods of the second distance D2 and the second angle a2 are respectively the same as the calculation methods of the first distance D1 and the first angle a1.

In S10 of FIG. 11, the main control device 60 obtains the first distance D1 and the first angle a1 from the front UWB anchor 78. Specifically, the main control device 60 obtains the first distance D1 and the first angle a1 from the front UWB anchor 78 in response to supplying a first obtaining instruction for obtaining the first distance D1 and the first angle a1 to the front UWB anchor 78. Here, when the front UWB anchor 78 has not received the beacon signal from the UWB tag 200, the main control device 60 receives not-receiving information indicating that the beacon signal has not been received from the front UWB anchor 78.

In S12, the main control device 60 obtains the second distance D2 and the second angle a2 from the rear UWB anchor 108. Specifically, the main control device 60 obtains the second distance D2 and the second angle a2 from the rear UWB anchor 108 in response to supplying a second obtaining instruction for obtaining the second distance D2 and the second angle a2 to the rear UWB anchor 108. When the rear UWB anchor 108 has not received the beacon signal from the UWB tag 200, the main control device 60 obtains the not-receiving information indicating that the beacon signal has not been received from the rear UWB anchor 108.

In S20, the main control device 60 determines whether the UWB tag 200 is located in a following operation permitted area. The following operation permitted area is an area in which execution of a following operation of moving by following the UWB tag 200 is permitted. As illustrated in FIG. 12, the following operation permitted area is an area frontward of the front UWB anchor 78. Further, an area directly laterally next to the front UWB anchor 78 and rearward of the front UWB anchor 78 is a following operation prohibited area in which the execution of the following operation is prohibited. The main control device 60 determines whether the UWB tag 200 is located in the following operation permitted area or not by using the first distance D1 obtained from the front UWB anchor 78, the second distance D2 obtained from the rear UWB anchor 108, and a third distance D3 between the front UWB anchor 78 and the rear UWB anchor 108. Here, the third distance D3 is pre-stored in a memory (not illustrated) of the main control device 60. The main control device 60 calculates a third angle a3 by using the first distance D1, the second distance D2, the third distance D3, and a following Formula (1). The third angle a3 is an angle between the first line L1 and a third line L3 connecting the front UWB anchor 78 and the rear UWB anchor 108. In the present embodiment, the third line L3 and the line L0 are parallel to each other.

$$\begin{matrix}[ Formula 1 ] & \\ cos ( a 3 ) = \frac{D {1}^{2} + D {3}^{2} - D {2}^{2}}{2 \times D 1 \times D 3} & ( 1 )\end{matrix}$$

With reference to FIG. 12, a case where the UWB tag 200 is located frontward of the front UWB anchor 78 will be described. In this case, in response to the second distance D2 being longer than the first distance D1, the third angle a3 is an obtuse angle. For this reason, when the third angle a3 is an obtuse angle, it can be determined that the UWB tag 200 is located in the following operation permitted area.

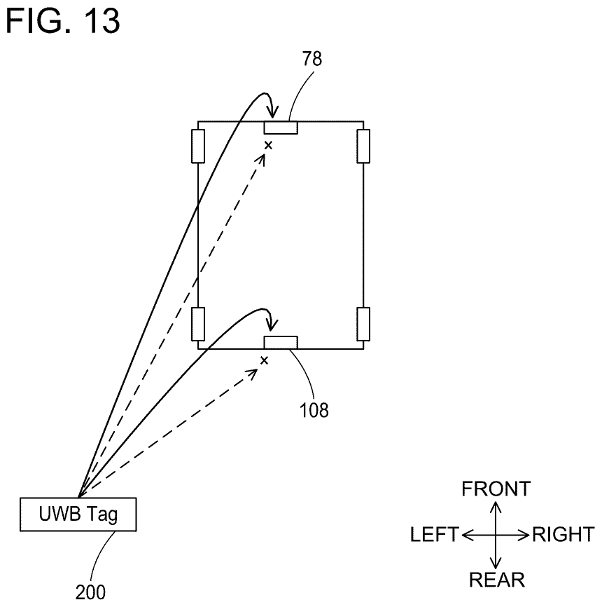

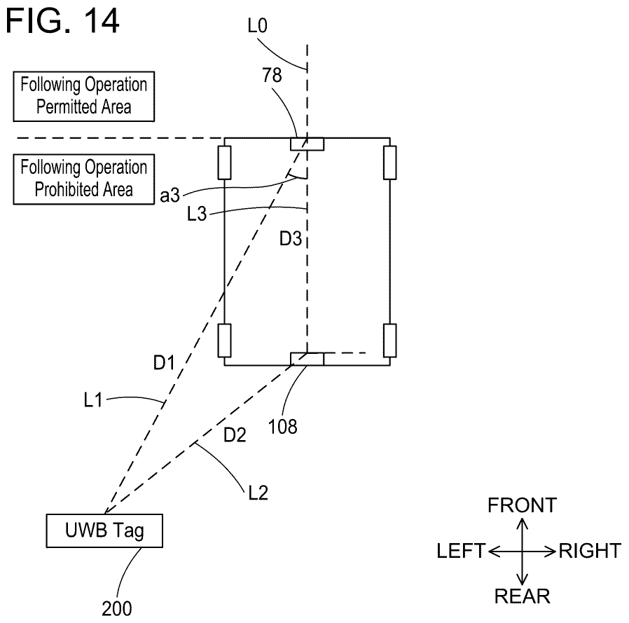

With reference to FIGS. 13 and 14, a case where the UWB tag 200 is located rearward of the front UWB anchor 78 will be described. In the present embodiment, the front UWB anchor 78 and the rear UWB anchor 108 respectively have the shield 88 (see FIG. 6) and a shield 118 (see FIG. 9). Due to this, as illustrated in FIG. 13, the first antenna 82 and the second antenna 84 of the front UWB anchor 78 and the third antenna 112 and the fourth antenna 114 of the rear UWB anchor 108 do not receive much of the beacon signals sent from the rear sides of the front UWB anchor 78 and the rear UWB anchor 108 (broken-line arrows in FIG. 13). However, the beacon signal(s) from the rear sides of the front UWB anchor 78 and the rear UWB anchor 108 may turn around to the front sides of the front UWB anchor 78 and the rear UWB anchor 108 and thus reach the first antenna 82 and the second antenna 84 of the front UWB anchor 78 and the third antenna 112 and the fourth antenna 114 of the rear UWB anchor 108 (bold-line arrows in FIG. 13). FIG. 14 illustrates a situation where the beacon signals sent from the rear sides of the front UWB anchor 78 and the rear UWB anchor 108 turn around to the front sides of the front UWB anchor 78 and the rear UWB anchor 108 and reach the first antenna 82 and the second antenna 84 of the front UWB anchor 78 and the third antenna 112 and the fourth antenna 114 of the rear UWB anchor 108, in a more understandable form. In this case, as illustrated in FIG. 14, in response to the first distance D1 being longer than the second distance D2, the third angle a3 is an acute angle. Due to this, by using the third angle a3, it can be specified that the UWB tag 200 is located in the following operation prohibited area. Also when the UWB tag 200 is located frontward of the front UWB anchor 78 and also rearward of the rear UWB anchor 108, the third angle a3 is an acute angle.

Back to FIG. 11, in S20, when the third angle a3 is an obtuse angle, the main control device 60 determines that the UWB tag 200 is located frontward of the front UWB anchor 78. In this case, the main control device 60 determines that the UWB tag 200 is located in the following operation permitted area (YES to S20), and the process proceeds to S22. Contrary to this, when the third angle a3 is not an obtuse angle, the main control device 60 determines that the UWB tag 200 is not located frontward of the front UWB anchor 78. In this case, the main control device 60 determines that the UWB tag 200 is located in the following operation prohibited area (NO to S20), and the process proceeds to S30.

When in S10 the not-receiving information has been received from the front UWB anchor 78 or when in S12 the not-receiving information has been received from the rear UWB anchor 108, the main control device 60 determines that the UWB tag 200 is located in the following operation prohibited area (NO to S20), and the process proceeds to S30. When the not-receiving information is obtained, it is likely that the UWB tag 200 is located rearward of the front UWB anchor 78 or the rear UWB anchor 108.

In S22, the main control device 60 determines a target velocity TV and a target angular velocity Tω of the cart 2 so that the cart 2 follows the UWB tag 200 by using the first distance D1 and the first angle a1 that are obtained from the front UWB anchor 78.

In S24, the main control device 60 controls the operation of the cart 2. Specifically, the main control device 60 controls the operations of the right front wheel motor 140A, the left front wheel motor 140B, the right rear wheel motor 140C, the left rear wheel motor 140D, and the steering motor 134 based on the target velocity TV and the target angular velocity Tω. When S24 ends, the process returns to S10. For example, when the UWB tag 200 moves from the following operation prohibited area to the following operation permitted area while the cart 2 remains stopped, the main control device 60 controls the operations of the right front wheel motor 140A, the left front wheel motor 140B, the right rear wheel motor 140C, the left rear wheel motor 140D, and the steering motor 134 so that the cart 2 travels.

In S30, the main control device 60 decides the target velocity TV and the target angular velocity Tω of the cart 2 to be zero. When S30 ends, the process proceeds to S24.

In S24 after S30, the main control device 60 controls the operation of the cart 2 so that the cart 2 does not travel. For example, when the UWB tag 200 moves from the following operation permitted area to the following operation prohibited area while the cart 2 is traveling, the main control device 60 controls operation of the brake circuit so that the cart 2 stops. Also when the UWB tag 200 moves from the following operation permitted area to the following operation prohibited area while the cart 2 remains stopped, the main control device 60 does not drive the right front wheel motor 140A, the left front wheel motor 140B, the right rear wheel motor 140C, the left rear wheel motor 140D, and the steering motor 134.

As mentioned above, the main control device 60 can accurately determine whether the UWB tag 200 is located in the following operation permitted area or not by using the first distance D1, the second distance D2, and the third distance D3. Accordingly, the following operation can be suppressed from being executed when the UWB tag 200 is located in the following operation prohibited area.

Hereafter, the main control device 60 and the anchor control devices 86, 116 will be collectively referred to as “control unit”.

In one or more embodiments, the cart 2 comprises: the body unit 4; the wheels 10 (example for “ground contact part”) supported by the body unit 4 and configured to be in contact with a ground; the traction motor 140 (example for “prime mover”) configured to drive the wheels 10; the front UWB anchor 78 (example for “first UWB anchor”) including the first antenna 82 and the second antenna 84 and configured to receive the beacon signal from the UWB tag 200 configured to be carried by a user; the rear UWB anchor 108 (example for “second UWB anchor”) disposed rearward of the front UWB anchor 78 and configured to receive the beacon signal from the UWB tag 200; and the control unit (example for “control device”) configured to execute the following operation of causing the cart 2 to follow the UWB tag 200 by driving the traction motor 140. The control unit is configured to calculate the first distance D1 between the front UWB anchor 78 and the UWB tag 200 and the first angle a1 (example for “a first tag angle”) of the UWB tag 200 relative to the front UWB anchor 78 by using the beacon signal received by the first antenna 82 and the beacon signal received by the second antenna 84.

According to the above configuration, by using the front UWB anchor 78 and the rear UWB anchor 108 with different positions in the front-rear direction, the position of the UWB tag 200, that is, the position of the user can be calculated with high precision.

In one or more embodiments, the control unit is configured to calculate the second distance D2 between the rear UWB anchor 108 and the UWB tag 200 by using the beacon signal received by the rear UWB anchor 108, and configured to determine whether the UWB tag 200 is located in the following operation permitted area (example for “a first area”) in which execution of the following operation is permitted or the following operation prohibited area (example for “a second area”) in which the execution of the following operation is prohibited by using the first distance D1 and the second distance D2.

According to the above configuration, by using the front UWB anchor 78 and the rear UWB anchor 108 with different positions in the front-rear direction, whether the user is located in the following operation permitted area or in the following operation prohibited area can be determined with high precision. Also, according to the above configuration, only when the user is located in the following operation permitted area, the cart 2 can be caused to execute the following operation.

In one or more embodiments, the front UWB anchor 78 is located frontward of the rear UWB anchor 108. The first antenna 82 and the second antenna 84 are aligned in the left-right direction. The midpoint between the first antenna 82 and the second antenna 84 in the left-right direction matches the center of the rear UWB anchor 108. When the third angle a3 (example for “second tag angle”) between the first line L1 (example for “a first virtual line”) connecting the front UWB anchor 78 and the UWB tag 200 and the third line L3 (example for “a second virtual line”) connecting the front UWB anchor 78 and the rear UWB anchor 108 is an obtuse angle, the control unit determines that the UWB tag 200 is located in the following operation permitted area, and when the third angle a3 is 90 degrees or an acute angle, the control unit determines that the UWB tag 200 is located in the following operation prohibited area.

There is a case where an area in which the user is located frontward of the front UWB anchor 78 is the following operation permitted area and an area in which the user is located directly laterally next to the front UWB anchor 78 or rearward of the front UWB anchor 78 is the following operation prohibited area. When the third angle a3 is an obtuse angle, the user is located frontward of the front UWB anchor 78, when the third angle a3 is 90°, the user is directly laterally next to the front UWB anchor 78, and when the third angle a3 is an acute angle, the user is located rearward of the front UWB anchor 78. Accordingly, whether the user is located in the following operation permitted area or in the following operation prohibited area can be determined with high precision.

In one or more embodiments, when the control unit determines that the UWB tag 200 is located in the following operation permitted area, the control unit calculates the target velocity TV and the target angular velocity Tω by using the first distance D1 and the first angle a1 to control the traction motor 140.

According to the above configuration, when the user is located in the following operation permitted area, the cart 2 can be caused to operate so as to follow the user.

In one or more embodiments, when the control unit determines that the UWB tag 200 has moved from the following operation permitted area to the following operation prohibited area, the control unit stops the traction motor 140, and when the control unit determines that the UWB tag 200 has moved from the following operation prohibited area to the following operation permitted area, the control unit drives the traction motor 140.

According to the above configuration, under a situation where the user is located in the following operation prohibited area, the cart 2 can be suppressed from traveling. Accordingly, the cart 2 can be caused to properly execute the following operation.

In one or more embodiments, the front UWB anchor 78 has a higher receiving sensitivity for signals arriving from the front side than for signals arriving from the rear side.

According to the above configuration, it becomes less likely that the beacon signal sent from the UWB tag 200 located in the following operation prohibited area is received. In this case, when the beacon signal is not received, the control unit can determine that the UWB tag 200 is located in the following operation prohibited area. Accordingly, whether the UWB tag 200 is located in the following operation prohibited area or not can be easily determined.

In one or more embodiments, the cart 2 further comprises the load platform 6 supported by the body unit 4. The front UWB anchor 78 is located frontward of the load platform 6.

A luggage/cargo is carried on the load platform 6. When the UWB tag is located on the front side of the cart 2 and the front UWB anchor 78 is located rearward of the load platform 6, the beacon signal from the UWB tag 200 may be interrupted by the luggage/cargo carried on the load platform 6, as a result of which the front UWB anchor 78 cannot receive the beacon signal. According to the above configuration, because the beacon signal from the UWB tag 200 is not interrupted by the luggage/cargo carried on the load platform 6, a possibility of the front UWB anchor 78 receiving the beacon signal can be increased.

In one or more embodiments, the rear UWB anchor 108 is located rearward of the load platform 6. The rear UWB anchor 108 is located above the front UWB anchor 78 and the load platform 6.

The beacon signal from the UWB tag 200 may not be received by the rear UWB anchor 108 due to being interrupted by the load platform 6. According to the above configuration, because the beacon signal from the UWB tag 200 is not interrupted by the luggage/cargo carried on the load platform 6, a possibility of the rear UWB anchor 108 receiving the beacon signal from the UWB tag 200 can be increased.

In one or more embodiments, the cart 2 further comprises the handle part 96 including the grips 96A, 96B configured to be grasped by the user. The handle part 96 is located above the load platform 6 and the rear UWB anchor 108 is disposed in or on the handle part 96.

According to the above configuration, the rear UWB anchor 108 can be easily disposed above the load platform 6.

(First Modification) One of the front UWB anchor 78 and the rear UWB anchor 108 may include one antenna only. In the present modification, the main control device 60 controls operation of the cart 2 by using a distance and an angle that are calculated by the one of the front UWB anchor 78 and the rear UWB anchor 108 which includes the two antennas.

(Second Modification) In S22 of FIG. 11, the control unit may determine the target velocity TV and the target angular velocity Tω of the cart 2 by using the second distance D2 and the second angle a2 that are obtained from the rear UWB anchor 108.

(Third Modification) In the left-right direction, the center of the front UWB anchor 78 and the center of the rear UWB anchor 108 may not match. In this case, the control unit executes the process of S20 in FIG. 11 by correcting a discrepancy between the center of the front UWB anchor 78 and the center of the rear UWB anchor 108.

(Fourth Modification) The control unit may determine whether the UWB tag 200 is located in the following operation permitted area or not by using the first distance D1 and the second distance D2. For example, when the first distance D1 is longer than the second distance D2, the control unit determines that the UWB tag 200 is located in the following operation permitted area.

(Fifth Modification) Also when the operation mode of the cart 2 is the manual mode or the parking mode, the control unit may specify whether the UWB tag 200 is located in the following operation permitted area or not.

(Sixth Modification) At least one of or both of the front UWB anchor 78 and the rear UWB anchor 108 may not comprise the shield 88, 118.

(Seventh Modification) Both of the front UWB anchor 78 and the rear UWB anchor 108 may be disposed frontward of the load platform 6 or may be disposed rearward of the load platform 6. Further, at least one of the front UWB anchor 78 and the rear UWB anchor 108 may be disposed on a lateral side of the load platform 6.

(Eighth Modification) The “prime mover” may not be limited to the traction motor 140, and may be an engine, for example.

(Ninth Modification) The “ground contact part” may not limited to wheel(s), but may be crawler(s), for example.

(Tenth Modification) An area frontward of the front UWB anchor 78 may be a forward following area in which a following operation of causing the cart 2 to move forward and following the UWB tag 200 is executed and an area rearward of the front UWB anchor 78 may be a retract travel area in which a following operation of causing the cart 2 to retract rearward and following the UWB tag 200 is executed. In this case, an area directly laterally next to the front UWB anchor 78 is preferably a stop area in which the following operation is not executed. In the present modification, the “forward following area” and the “retract following area” are an example of “first area” and “second area”, respectively.

(Eleventh Modification) An area frontward of the front UWB anchor 78 may be a front lighting area in which the right front light 73A and the left front light 73B both light and an area rearward of the front UWB anchor 78 may be a rear lighting area in which the tail light 101 lights. In this case, the area directly laterally next to the front UWB anchor 78 is preferably a light off area in which the right front light 73A, the left front light 73B, and the tail light 101 all do not light. In the present modification, the “front lighting area” and the “rear lighting area” are an example of “first area” and “second area”, respectively.

Some of further features of the cart 2 disclosed in the present embodiment will be listed hereinbelow.

### (Feature 1-1)

A detector comprising:
a light emitting element;
a light receiving element disposed to face the light emitting element;
a shield plate configured to shield light emitted by the light emitting element; and
a control unit,
wherein the control unit applies a pulsing voltage on the light emitting element so that the light emitting element intermittently emits light,
the light receiving element intermittently receives the light emitted by the light emitting element when the shield plate does not shield the light emitted by the light emitting element, and
the light receiving element does not receive the light emitted by the light emitting element when the shield plate shields the light emitted by the light emitting element.

### (Feature 1-2)

The detector according to feature 1-1, wherein the light receiving element continuously receives the light emitted by the light emitting element when a short circuit abnormality is occurring in the light emitting element and the shield plate does not shield the light emitted by the light emitting element.

### (Feature 1-3)

A cart comprising:
a load platform;
a ground contact part configured to be in contact with a ground;
a prime mover configured to drive the ground contact part;
a detector attached to the load platform and according to feature 1-1 or 1-2; and
a control unit configured to control operation of the prime mover,
wherein the control unit permits to drive the prime mover when the light receiving element of the detector receives intermittently the light emitted by the light emitting element, and the control unit prohibits driving of the prime mover when the light receiving element does not receive the light emitted by the light emitting element.

### (Feature 1-4)

The cart according to feature 1-3, wherein when a load of a predetermined upper limit load or more is applied from the load platform on the shied plate of the detector, the light emitted by the light emitting element of the detector is shielded by the shield plate, and
when a load less than the predetermined upper limit load is applied from the load platform on the shield plate of the detector, the light emitted by the light emitting element of the detector is not shielded by the shield plate.

Effects brought by the above-mentioned features 1-1 to 1-4 will be described.

In one or more embodiments, the overload detection mechanism 26 (example for “detector”) comprises: the light emitting element 50; the light receiving element 52 disposed to face the light emitting element 50; the detection plate 40 (example for “shield plate”) configured to shield the light emitted by the light emitting element 50, and the control unit. The control unit applies a pulsing voltage on the light emitting element 50 so that the light emitting element 50 intermittently emits light. The light receiving element 52 intermittently receives the light emitted by the light emitting element 50 when the detection plate 40 does not shield the light emitted by the light emitting element 50, and the light receiving element 52 does not receive the light emitted by the light emitting element 50 when the detection plate 40 shields the light emitted by the light emitting element 50.

According to the above configuration, the control unit can detect whether the detection plate 40 is shielding the light emitted by the light emitting element 50 according to whether the light receiving element 52 is intermittently receiving the light emitted by the light emitting element 50 or not.

In one or more embodiments, the light receiving element 52 continuously receives the light emitted by the light emitting element 50 when a short circuit abnormality is occurring in the light emitting element 50 and also the detection plate 40 does not shield the light emitted by the light emitting element 50.

According to the above configuration, the control unit can detect that a short circuit abnormality is occurring in the light emitting element 50 when the light receiving element 52 continuously receives the light emitted by the light emitting element 50.

In one or more embodiments, the cart 2 comprises: the load platform 6; the wheels 10 (example for “ground contact part”) configured to be in contact with a ground; the traction motor 140 (example for “prime mover”) configured to drive the wheels 10; the overload detection mechanism 26 (example for “detector”) attached to the load platform 6; and the control unit configured to control operation of the traction motor 140. The control unit permits to drive the traction motor 140 when the light receiving element 52 receives intermittently the light emitted by the light emitting element 50, and the control unit prohibits the traction motor 140 when the light receiving element 52 does not receive the light emitted by the light emitting element 50.

When the light receiving element 52 does not receive the light emitted by the light emitting element 50, it is likely that some sort of abnormality is occurring in the cart 2. According to the above configuration, when some sort of abnormality is occurring in the cart 2, the cart 2 can be suitably suppressed from traveling.

In one or more embodiments, when a load of a predetermined upper limit load or more is applied from the load platform 6 on the detection plate 40 (example for “shield plate”), the light emitted by the light emitting element 50 is shielded by the detection plate 40, and when a load less than the predetermined upper limit load is applied from the load platform 6 on the detection plate 40, the light emitted by the light emitting element 50 is not shielded by the detection plate 40.

A case where the light emitting element 50 is emitting continuous light under a normal state with no abnormality such as disconnection or short-circuit occurring will be described. In this case, when there is no overload and short circuit is occurring, the light emitting element 50 continuously emits light. Due to this, the main control device 60 cannot distinguish whether there is no overload or there is a short-circuit when the main control device 60 continuously receives the ON signal from the detection sensor 42. According to the above configuration, the overload detection mechanism 26 enables to determine precisely whether there is overload or not. Accordingly, when there is overload, the cart 2 can be suitably suppressed from traveling.

(Modification 1-1) The “detector” can be implemented in a robotic cleaner, not only in the cart 2.

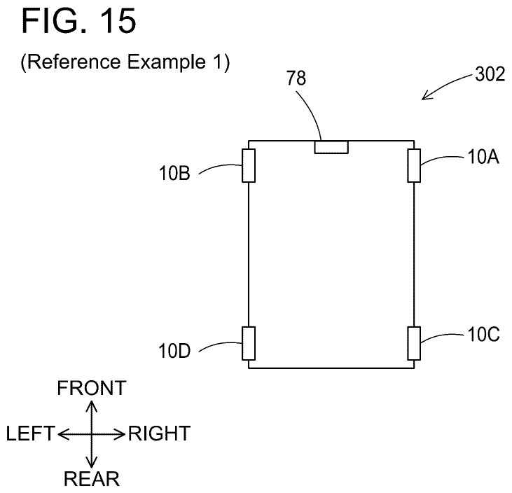

(Reference Example 1) With reference to FIGS. 15 to 17, a cart 302 according to reference example 1 will be described. Hereafter, mainly, differences between the cart 302 of the reference example 1 and the cart 2 of the first embodiment will be described, and descriptions of like points will be omitted.

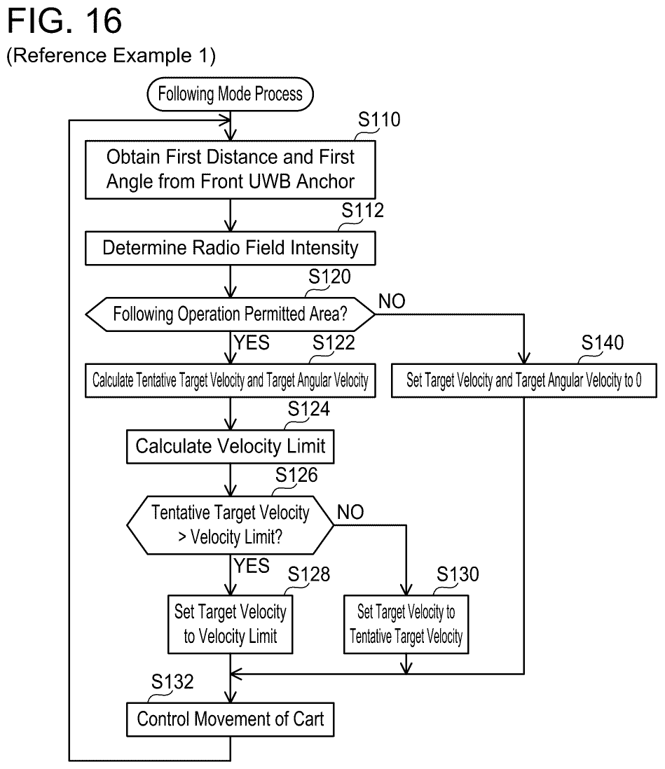

As illustrated in FIG. 15, the cart 302 of the reference example 1 differs from the cart 2 of the first embodiment in that the cart 302 does not have the rear UWB anchor 108. Further, the main control device 60 (see FIG. 5) in the reference example 1 executes the following mode process of FIG. 16 instead of the following mode process of FIG. 12.

(Following Mode Process; FIG. 16) With reference to FIG. 16, the following mode process executed by the main control device 60 will be described. The main control device 60 starts processes of FIG. 16 when the operation mode of the cart 302 is set to the following mode.

In S110, the main control device 60 obtains the first distance D1 and the first angle a1 from the front UWB anchor 78. Specifically, in response to supplying a first obtaining instruction for obtaining the first distance D1 and the first angle a1 to the front UWB anchor 78, the main control device 60 obtains the first distance D1 and the first angle a1 from the front UWB anchor 78. Here, when the front UWB anchor 78 has not received the beacon signal from the UWB tag 200, the main control device 60 obtains not-receiving information indicating that the beacon signal has not been received from the front UWB anchor 78.

In S112, the main control device 60 determines a radio field intensity threshold by using the first distance D1 obtained in S110. The radio field intensity threshold is a threshold for determining whether the UWB tag 200 is located in the following operation permitted area or not. The main control device 60 sets a smaller radio field intensity threshold when the first distance D1 is longer.

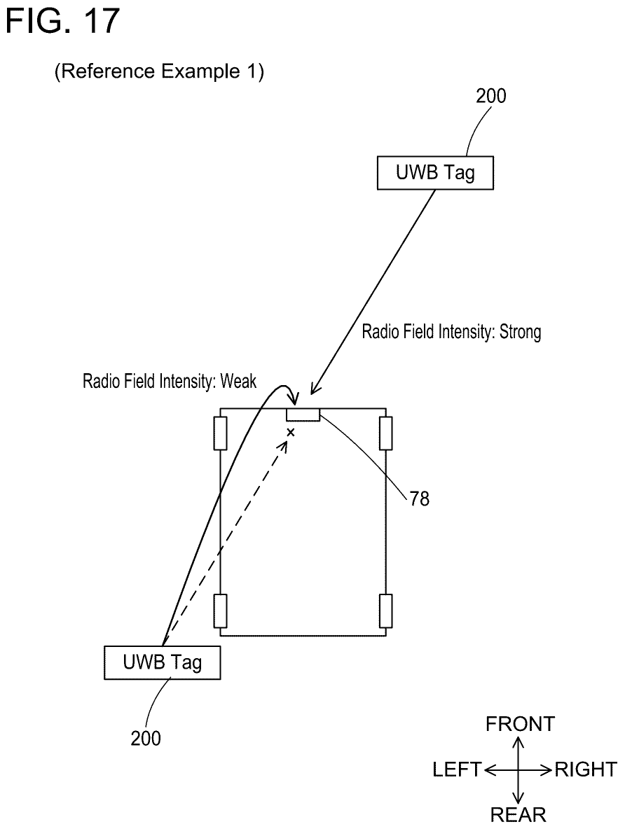

In S120 of FIG. 16, the main control device 60 determines whether the UWB tag 200 is located in the following operation permitted area or not. Specifically, the main control device 60 determines whether the radio field intensity of the beacon signal received by the front UWB anchor 78 exceeds the radio field intensity threshold determined in S112 or not. With reference to FIG. 17, the radio field intensity of the beacon signal will be described. In the present reference example, the front UWB anchor 78 has the shield 88 (see FIG. 6). Due to this, as illustrated in FIG. 17, the first antenna 82 and the second antenna 84 of the front UWB anchor 78 does not receive much of the beacon signals sent from the rear side of the front UWB anchor 78 (broken-line arrow in FIG. 17). However, a beacon signal from the rear side of the front UWB anchor 78 may turn around to the front side of the front UWB anchor 78 and reach the first antenna 82 and the second antenna 84 (solid-line arrow in FIG. 17). Because the beacon signal turns around to the front side of the front UWB anchor 78, the radio field intensity of this beacon signal is low. Due to this, the radio field intensity of the beacon signal which turns from the rear side of the front UWB anchor 78 over to the front side of the front UWB anchor 78 and reaches the first antenna 82 and the second antenna 84 has a lower radio field intensity than that of the beacon signal which reaches the first antenna 82 and the second antenna 84 from the front side of the front UWB anchor 78.

Back to FIG. 16, when the radio field intensity exceeds the radio field intensity threshold, the main control device 60 determines that the UWB tag 200 is located in the following operation permitted area (YES to S120), the process proceeds to S122. Contrary to this, when the radio field intensity is equal to or lower than the radio field intensity threshold, the main control device 60 determines that the UWB tag 200 is located in the following operation prohibited area (NO to S120), and the process proceeds to S140.

When in S110 the main control device 60 has received the not-receiving information from the front UWB anchor 78, the main control device 60 determines that the UWB tag 200 is located in the following operation prohibited area (NO to S120), and the process proceeds to S140. This is because, when the not-receiving information is obtained, it is likely that the UWB tag 200 is located rearward of the front UWB anchor 78.

In S122, the main control device 60 calculates a tentative target velocity TTV and a target angular velocity Tω by using the first distance D1 and the first angle a1 so that the cart 2 follows the UWB tag 200. Specifically, the main control device 60 calculates the tentative target velocity TTV by using the first distance D1 and a following Formula (2), and calculates the target angular velocity Tω by using the first angle a1 and a following Formula (3). “Vg1”, “Vo1” in the Formula (2) are respectively a first velocity gain and a first velocity offset. The first velocity offset Vo1 is a value for stopping the cart 302 in front of the user. “ωg1” of the Formula (3) is a first angular velocity gain.

$$\begin{matrix}[ Formula 2 ] & \\ TTV = ( D 1 \times Vg 1 ) - Vo 1 & ( 2 )\end{matrix}$$

$$\begin{matrix}[ Formula 3 ] & \\ T ω = a 1 \times ωg1 & ( 3 )\end{matrix}$$

In S124, the main control device 60 calculates a limit velocity VL by using the first angle a1. Specifically, the main control device 60 calculates the limit velocity VL by using a following Formula (4). “Vmax”, “Vo2” in the Formula (4) are a maximum velocity and a second velocity offset of the cart 302. The second velocity offset Vo2 is a value determined according to the first angle a1. The second velocity offset Vo2 increases as the first angle a1 increases. That is, as the first angle a1 increases, the limit velocity VL decreases.

$$\begin{matrix}[ Formula 4 ] & \\ VL = V max - Vo 2 & ( 4 )\end{matrix}$$

In S126, the main control device 60 determines whether the tentative target velocity TTV exceeds the limit velocity VL or not. When the main control device 60 determines that the tentative target velocity TTV exceeds the limit velocity VL (YES to S126), the process proceeds to S128. Contrary to this, when the main control device 60 determines that the tentative target velocity TTV does not exceed the limit velocity VL (NO to S126), the process proceeds to S130.

In S128, the main control device 60 decides the limit velocity VL as the target velocity TV.

Further, in S130, the main control device 60 decides the tentative target velocity TTV as the target velocity TV.

In S132, the main control device 60 controls operation of the cart 302. Specifically, the main control device 60 controls operations of the right front wheel motor 140A, the left front wheel motor 140B, the right rear wheel motor 140C, the left rear wheel motor 140D, and the steering motor 134 based on the target velocity TV and the target angular velocity Tω. When S132 ends, the process returns to S110.

Also, in S140, the main control device 60 decides the target velocity TV and the target angular velocity Tω of the cart 302 to be zero. When S140 ends, the process proceeds to S132.

In S132 after S140, the main control device 60 prohibits the cart 302 from traveling.

As mentioned above, the main control device 60 can accurately determine whether the UWB tag 200 is located in the following operation permitted area or not by using the radio field intensity and the radio field intensity threshold. Accordingly, when the UWB tag 200 is located in the following operation prohibited area, the following operation can be suppressed from being executed.

Some of features of the cart 302 disclosed in the present reference example will be listed hereinbelow.

### (Feature 2-1)

A cart comprising:
a body unit;
a ground contact part supported by the body unit and configured to be in contact with a ground;
a prime mover configured to drive the ground contact part;
a UWB anchor configured to receive a beacon signal from a UWB tag configured to be carried by a user; and
a control unit,
wherein the UWB anchor has a higher receiving sensitivity for signals arriving from a front side than for signals arriving from a rear side, and
the control unit determines whether the UWB tag is located frontward of the UWB anchor or not by using a radio field intensity of the beacon signal received from the UWB tag.

### (Feature 2-2)

The cart according to feature 2-1, wherein the UWB anchor comprises a first antenna and a second antenna different from the first antenna, and
the control unit calculates a distance between the UWB anchor and the UWB tag and an angle of the UWB tag relative to the UWB anchor by using the beacon signal received by the first antenna and the beacon signal received by the second antenna.

### (Feature 2-3)

The cart according to feature 2-1 or feature 2-2, wherein the control unit determines that the UWB tag is located frontward of the UWB anchor when the radio field intensity exceeds the radio field intensity threshold, and
the control unit determines that the UWB tag is located rearward of the UWB anchor when the radio field intensity is equal to or lower than the radio field intensity threshold.

### (Feature 2-4)

The cart according to feature 2-3, wherein the control unit calculates the distance between the UWB tag and the UWB anchor by using the beacon signal received by the UWB anchor, and sets the radio field intensity threshold to be smaller as the distance is longer.

### (Feature 2-5)

The cart according to any one of features 2-1 to 2-4, further comprising a load platform supported by the body unit,
wherein the UWB anchor is disposed frontward of the load platform.

### (Feature 2-6)

The cart according to any one of features 2-1 to 2-5, wherein the cart comprises only one UWB anchor.

### (Feature 2-7)

The cart according to any one of features 2-1 to 2-6,
wherein the control unit determines that the UWB tag is located in a following operation permitted area in which moving to follow the UWB tag is permitted when the control unit determines that the UWB tag is located frontward of the UWB anchor,
the control unit determines that the UWB tag is located in the following operation prohibited area in which moving to follow the UWB tag is prohibited when the control unit determines that the UWB tag is located rearward of the UWB anchor, and
the control unit stops operation of the prime mover when the control unit determines that the UWB tag has moved from the following operation permitted area to the following operation prohibited area.

Some of effects by the above-described features 2-1 to 2-7 will be described.

In one or more embodiments, the cart 302 comprises: the body unit 4, the wheels 10 (example for “ground contact part”) supported by the body unit 4 and configured to be in contact with a ground; the traction motor 140 (example for “prime mover”) configured to drive the wheels 10; the front UWB anchor 78 (example for “UWB anchor”) configured to receive a beacon signal from the UWB tag 200 configured to be carried by a user; and the control unit. The front UWB anchor 78 has a higher receiving sensitivity for signals arriving from the front side than for signals arriving from the rear side. The control unit determines whether the UWB tag 200 is located frontward of the front UWB anchor 78 or not by using the radio field intensity of the beacon signal received from the UWB tag 200.

According to the above configuration, by utilizing the radio field intensity, whether the UWB tag 200, i.e., the user is located frontward of the front UWB anchor 78 or not can be acknowledged.

In one or more embodiments, the front UWB anchor 78 comprises the first antenna 82 and the second antenna 84. The control unit calculates the first distance D1 between the front UWB anchor 78 and the UWB tag 200 and the first angle a1 of the UWB tag 200 relative to the front UWB anchor 78 by using the beacon signal received by the first antenna 82 and the beacon signal received by the second antenna 84.

According to the above configuration, the position of the user can be more accurately grasped.

In one or more embodiments, the control unit determines that the UWB tag 200 is located frontward of the front UWB anchor 78 when the radio field intensity exceeds the radio field intensity threshold, and the control unit determines that the UWB tag 200 is located rearward of the front UWB anchor 78 when the radio field intensity is equal to or lower than the radio field intensity threshold.

According to the above configuration, whether the user is located frontward of the front UWB anchor 78 can be more accurately grasped.

In one or more embodiments, the control unit calculates the first distance D1 between the UWB tag 200 and the front UWB anchor 78 by using the beacon signal received by the front UWB anchor 78, and sets the radio field intensity threshold to be smaller as the first distance D1 is longer.

The longer the distance between the UWB tag 200 and the front UWB anchor 78, the smaller the radio field intensity. Accordingly, by making the radio field intensity threshold smaller as the first distance D1 is longer, irrespective of the distance between the UWB tag 200 and the front UWB anchor 78, the user can grasp whether the user is located frontward of the front UWB anchor 78.

In one or more embodiments, the cart 302 further comprises the load platform 6 supported by the body unit 4. The front UWB anchor 78 is arranged frontward of the load platform 6.

A luggage/cargo, for example, is carried on the load platform 6. When the UWB tag is located on the front side of the cart 2 and also the front UWB anchor 78 is located rearward of the load platform 6, the beacon signal from the UWB tag 200 may be interrupted by the load carried on the load platform 6, as a result of which the front UWB anchor 78 cannot receive the beacon signal. According to the above configuration, since the beacon signal from the UWB tag 200 is not interrupted by the luggage/cargo carried on the load platform 6, a possibility of the front UWB anchor 78 receiving the beacon signal can be increased. Also, because the receiving sensitivity of the front UWB anchor 78 for the front side is higher than the receiving sensitivity thereof for the rear side, by utilizing the radio field intensity, whether the user is located frontward of the front UWB anchor 78 or not can be accurately grasped.

n one or more embodiments, the cart 302 comprises only one front UWB anchor 78.

According to the above configuration, as compared to the configuration where two or more UWB anchors are used to grasp whether the user is located frontward of the front UWB anchor 78 or not, the configuration of the cart 302 can be simplified.

In one or more embodiments, the control unit determines that the UWB tag 200 is located in the following operation permitted area in which moving to follow the UWB tag 200 is permitted when the control unit determines that the UWB tag 200 is located frontward of the front UWB anchor 78, the control unit determines that the UWB tag 200 is located in the following operation prohibited area in which moving to follow the UWB tag 200 is prohibited when the control unit determines that the UWB tag 200 is located rearward of the front UWB anchor 78, and the control unit stops operation of the traction motor 140 when the control unit determines that the UWB tag 200 has moved from the following operation permitted area to the following operation prohibited area.

According to the above configuration, the cart 302 can be suppressed from traveling when the user is located in the following operation prohibited area. Accordingly, the cart 302 can be caused to suitably execute the following operation.

(Modification 2-1) The cart 302 of the reference example 1 may comprise two or more UWB anchors. In this case, at least one of the two or more UWB anchors may comprise two antennas. Specifically, the UWB anchor for detecting the radio field intensity and the UWB anchor for detecting a distance to a tag may be different.

(Modification 2-2) The radio field intensity threshold may be constant irrespective of how long the distance between the UWB tag 200 and the front UWB anchor 78 is.

(Modification 2-3) The front UWB anchor 78 of the reference example 1 may be disposed rearward of the load platform 6.

(Modification 2-4) The control unit may determine that the UWB tag 200 is located in a forward following area in which a following operation of causing the cart 302 to move forward and following the UWB tag 200 is executed when the control unit determines that the UWB tag 200 is located frontward of the front UWB anchor 78, and the control unit may determine that the UWB tag 200 is located in a retreat following area in which a following operation of causing the cart 302 to retreat and follow the UWB tag 200 is executed when the control unit determines that the UWB tag 200 is located rearward of the front UWB anchor 78.

(Modification 2-5) The control unit may determine that the UWB tag 200 is located in a front lighting area in which the right front light 73A and the left front light 73B light when the control unit determines that the UWB tag 200 is located frontward of the front UWB anchor 78, and may determine that the UWB tag 200 is located in a rear lighting area in which the tail light 101 lights when the control unit determines that the UWB tag 200 is located rearward of the front UWB anchor 78.

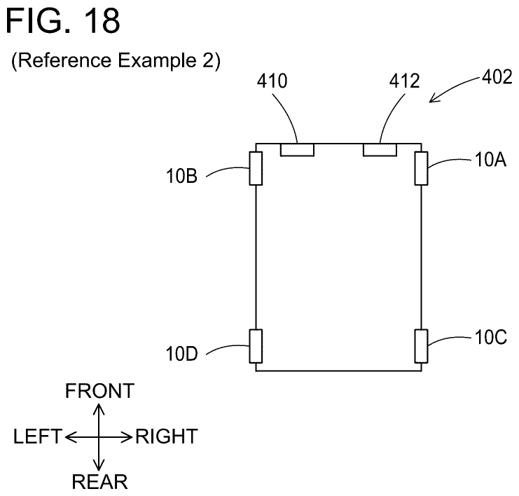

(Reference Example 2) With reference to FIGS. 18 to 21, a cart 402 according to a reference example 2 will be described. Hereafter, mainly, differences between the cart 402 of the reference example 2 and the cart 2 of the first embodiment will be described, and descriptions for like points will be omitted.

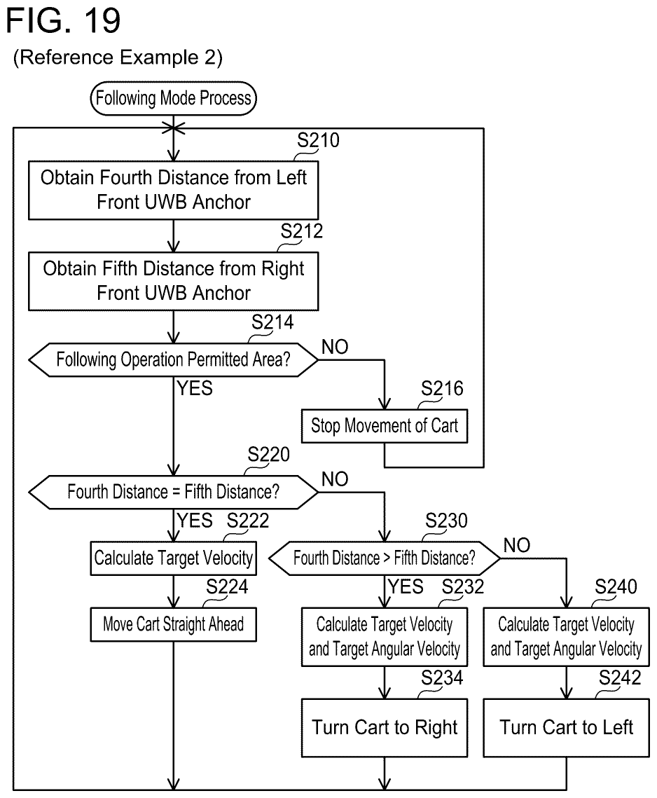

As illustrated in FIG. 18, the cart 402 of the reference example 2 differs from the cart 2 of the first embodiment in that the cart 402 of the reference example 2 comprises a right-front UWB anchor 412 and a left-front UWB anchor 410 instead of the front UWB anchor 78 (see FIG. 7) and the rear UWB anchor 108 (see FIG. 10). Also, the main control device 60 (see FIG. 5) of the reference example 2 executes a following mode process of FIG. 19 instead of the following mode process of FIG. 12.

The left-front UWB anchor 410 and the right-front UWB anchor 412 in FIG. 18 have a same configuration as the front UWB anchor 78 of the first embodiment (see FIGS. 6, 7). The left-front UWB anchor 410 and the right-front UWB anchor 412 are arranged in the housing 72 (see FIG. 1) of the cart 402. That is, the left-front UWB anchor 410 and the right-front UWB anchor 412 are arranged frontward of the load platform 6 (see FIG. 1). The left-front UWB anchor 410 is arranged to the left of the center of the cart 402 in the left-right direction. The right-front UWB anchor 412 is located to the right of the center of the cart 402 in the left-right direction. In the left-right direction, a midpoint between the two antennas of the left-front UWB anchor 410 and a midpoint between the two antennas of the right-front UWB anchor 412 are arranged at equal intervals from the center of the cart 2.

(Following Mode Process; FIG. 19) With reference to FIG. 19, the following mode process executed by the main control device 60 will be described. The main control device 60 starts processes of FIG. 19 when the operation mode of the cart 402 is set to the following mode.

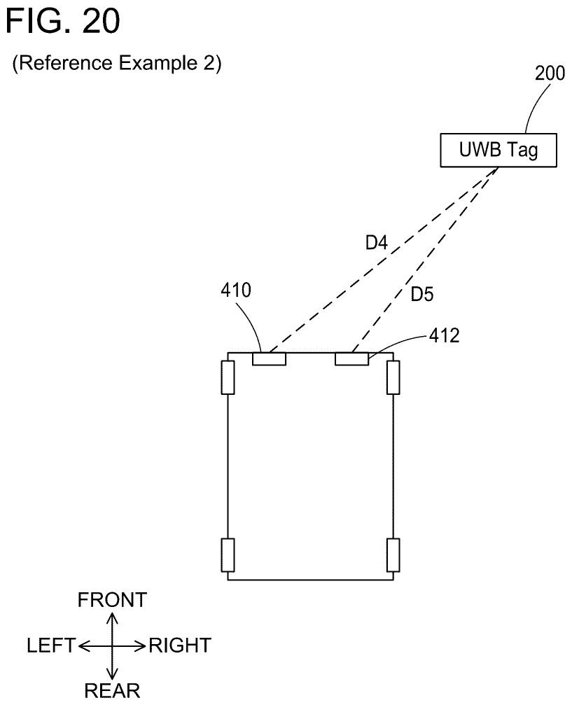

As illustrated in FIG. 20, when the left-front UWB anchor 410 receives the beacon signal from the UWB tag 200, the left-front UWB anchor 410 calculates a distance from the left-front UWB anchor 410 to the UWB tag 200 (hereafter, “fourth distance D4”). Also, when the right-front UWB anchor 412 receives the beacon signal from the UWB tag 200, the right-front UWB anchor 412 calculates a distance from the right-front UWB anchor 412 to the UWB tag 200 (hereafter, “fifth distance D5”). A method of calculating the fourth distance D4, the fifth distance D5 is the same as the method of calculating the first distance D1 of the first embodiment.

In S210 in FIG. 19, the main control device 60 obtains the fourth distance D4 from the left-front UWB anchor 410. Specifically, the main control device 60 obtains the fourth distance D4 from the left-front UWB anchor 410 in response to supplying a third obtaining instruction for obtaining the fourth distance D4 to the left-front UWB anchor 410. Here, when the left-front UWB anchor 410 has not received the beacon signal from the UWB tag 200, the main control device 60 obtains the not-receiving information indicating that the beacon signal has not been received from the left-front UWB anchor 410.

In S212, the main control device 60 obtains the fifth distance D5 from the right-front UWB anchor 412. Specifically, the main control device 60 obtains the fifth distance D5 from the right-front UWB anchor 412 in response to supplying a fourth obtaining instruction for obtaining the fifth distance D5 to the right-front UWB anchor 412. Here, when the right-front UWB anchor 412 has not received the beacon signal from the UWB tag 200, the main control device 60 obtains the not-receiving information indicating that the beacon signal has not been received from the right-front UWB anchor 412.

In S214, the main control device 60 determines whether the UWB tag 200 is located in the following operation permitted area or not. Specifically, the main control device 60 determines whether the not-receiving information has been received from at least one of the left-front UWB anchor 410 and the right-front UWB anchor 412 or not. When the main control device 60 determines that the not-receiving information has not been received, the main control device 60 determines that the UWB tag 200 is located frontward of the left-front UWB anchor 410 and the right-front UWB anchor 412. In this case, the main control device 60 determines that the UWB tag 200 is located in the following operation permitted area (YES to S214), and the process proceeds to S220. Contrary to this, when the main control device 60 determines that the not-receiving information has been received, the control device 60 determines that the UWB tag 200 is located rearward of the left-front UWB anchor 410 and the right-front UWB anchor 412. In this case, the main control device 60 determines that the UWB tag 200 is located in the following operation prohibited area (YES to S214), and the process proceeds to S216.

In S216, the main control device 60 decides the target velocity TV and the target angular velocity Tω of the cart 402 to be zero, and stops the cart 302. When S216 ends, the process returns to S210.

In S220, the main control device 60 assesses whether the fourth distance D4 and the fifth distance D5 match. When the main control device 60 determines that the fourth distance D4 and the fifth distance D5 match (YES to S220), the process proceeds to S222. Here, when the fourth distance D4 and the fifth distance D5 match is when the UWB tag 200 is located right in front of the cart 402. Contrary to this, when the main control device 60 determines that the fourth distance D4 and the fifth distance D5 do not match (NO to S220), the process proceeds to S230.

In S222, the main control device 60 calculates the target velocity TV of the cart 402. Specifically, the main control device 60 calculates the target velocity TV by using the fourth distance D4, the fifth distance D5, and a following Formula (5). “DA” and “Vg2” in the Formula (5) are respectively an average value of the fourth distance D4 and the fifth distance D5 and a second velocity gain.

$$\begin{matrix}[ Formula 5 ] & \\ TV = DA \times Vg 2 & ( 5 )\end{matrix}$$

In S224, the main control device 60 causes the cart 402 to move straight by using the target velocity TV. When S224 ends, the process returns to S210.

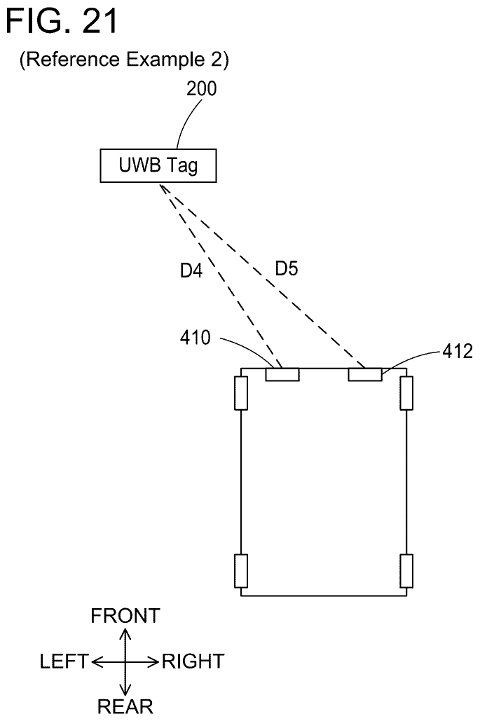

Also, in S230, the main control device 60 determines whether the fourth distance D4 is longer than the fifth distance D5. When the main control device 60 determines that the fourth distance D4 is longer than the fifth distance D5 (YES to S230), the process proceeds to S232. Here, when the fourth distance D4 is longer than the fifth distance D5 is when, as in FIG. 20, the UWB tag 200 is located to the right of the center of the cart 402 in the left-right direction. Contrary to this, when the main control device 60 determines that the fourth distance D4 is not longer than the fifth distance D5 (NO to S230), the process proceeds to S240. Here, when the fourth distance D4 is not longer than the fifth distance D5 is when, as in FIG. 21, the UWB tag 200 is located to the left of the center of the cart 402 in the left-right direction.

As illustrated in FIG. 19, in S232, the main control device 60 calculates the target velocity TV and the target angular velocity Tω of the cart 402 so that the cart 402 follows the UWB tag 200. A method of calculating the target velocity TV in the present step is the same as the method of calculating the target velocity TV in S222. The main control device 60 calculates the target angular velocity Tω by using the fourth distance D4, the fifth distance D5, and a following Formula (6). “ωg2” in the Formula (6) is a second angular velocity gain.

$$\begin{matrix}[ Formula 6 ] & \\ T ω = \vert D 4 - D 5 \vert \times ω g 2 & ( 6 )\end{matrix}$$

In S234, the main control device 60 causes the cart 402 to turn right by using the target velocity TV and the target angular velocity Tω. When S234 ends, the process returns to S210.

In S240, the main control device 60 calculates the target velocity TV and the target angular velocity Tω of the cart 402 so that the cart 402 follows the UWB tag 200. A method of calculating the target velocity TV in the present step is the same as the method of calculating the target velocity TV in S222. A method of calculating the target angular velocity Tω in the present step is the same as the method of calculating the target angular velocity Tω in S232.

In S242, the main control device 60 causes the cart 402 to turn left by using the target velocity TV and the target angular velocity Tω. When S242 ends, the process returns to S210.

As mentioned above, the main control device 60 can accurately determine whether the UWB tag 200 is located to the left or right to the center of the cart 402 in the left-right direction by using the fourth distance D4 and the fifth distance D5.

Some features of the cart 402 disclosed by the present reference example will be listed as below.

### (Feature 3-1)

A cart comprising:
a body unit;
a ground contact unit supported by the body unit and configured to be in contact with a ground;
a prime mover configured to drive the ground contact unit;
a first UWB anchor configured to receive a beacon signal from a UWB tag configured to be carried by a user;
a second UWB anchor arranged to the left of the first UWB anchor and configured to receive the beacon signal; and
a control unit configured to execute a following operation of causing the cart to follow the UWB tag by driving the prime mover,
wherein the control unit is configured to:
calculate a first tag distance which is a distance between the first UWB anchor and the UWB tag by using the beacon signal received by the first UWB anchor,
calculate a second tag distance which is a distance between the second UWB anchor and the UWB tag by using the beacon signal received by the second UWB anchor, and
determine whether the UWB tag is located to the right of the cart, or the UWB tag is located to the left of the cart based on the first tag distance and the second tag distance.

### (Feature 3-2)

The cart according to feature 3-1, wherein the control unit determines a target angular velocity of the cart based on an absolute value of a difference between the first tag distance and the second tag distance.

### (Feature 3-3)

The cart according to feature 3-1 or 3-2, wherein the control unit determines a target velocity of the cart based on an average value of the first tag distance and the second tag distance.

Effects brought by the above-mentioned features 3-1 to 3-3 will be described.

In one or more embodiments, the cart 402 comprises: the body unit 4; the wheels 10 (example for a ground contact unit) supported by the body unit 4 and configured to be in contact with a ground; the traction motor 140 (example for a prime mover) configured to drive the wheels 10; the right-front UWB anchor 412 (example for a first UWB anchor) configured to receive the beacon signal from the UWB tag 200 configured to be carried by a user; the left-front UWB anchor 410 (example for “second UWB anchor”) arranged to the left of the right-front UWB anchor 412 and configured to receive the beacon signal; and the control unit configured to execute a following operation of causing the cart 402 to follow the UWB tag 200 by driving the traction motor 140. The control unit is configured to: calculate the fourth distance D4 (example for “first tag distance”) between the right-front UWB anchor 412 and the UWB tag 200 by using the beacon signal received by the right-front UWB anchor 412, calculate the fifth distance D5 (example for “second tag distance”) between the left-front UWB anchor 410 and the UWB tag 200 by using the beacon signal received by the left-front UWB anchor 410, and determine whether the UWB tag 200 is located to the right of the cart 402, or the UWB tag 200 is located to the left of the cart 402 based on the fourth distance D4 and the fifth distance D5.

According to the above configuration, by using the right-front UWB anchor 412 and the left-front UWB anchor 410 with different positions in the left-right direction, the position of the UWB tag 200 in the left-right direction, i.e., the position of the user in the left-right direction can be suitably determined.

In one or more embodiments, the control unit determines the target angular velocity Tω of the cart based on the absolute value of the difference between the fourth distance D4 and the fifth distance D5.

According to the above configuration, the angular velocity of the cart 402 can be adjusted according to the distance between the cart 402 and the user.

In one or more embodiments, the control unit determines the target velocity TV of the cart 402 based on the average value of the fourth distance D4 and the fifth distance D5.

According to the above configuration, the velocity of the cart 402 can be adjusted according to the distance between the cart 402 and the user.

(Modification 3-1) At least one of the right-front UWB anchor 412 and the left-front UWB anchor 410 may comprise one antenna only.

(Modification 3-2) Positions of the right-front UWB anchor 412 and the left-front UWB anchor 410 in the front-rear direction may differ from each other.

(Modification 3-3) The right-front UWB anchor 412 and the left-front UWB anchor 410 may be arranged rearward of the load platform 6.

(Modification 3-4) In S222 of FIG. 19, the main control device 60 may calculate the target velocity TV by using one of the fourth distance D4 and the fifth distance D5. Further, in S232, S240, the main control device 60 may calculate the target velocity TV and the target angular velocity Tω by using one of the fourth distance D4 and the fifth distance D5.

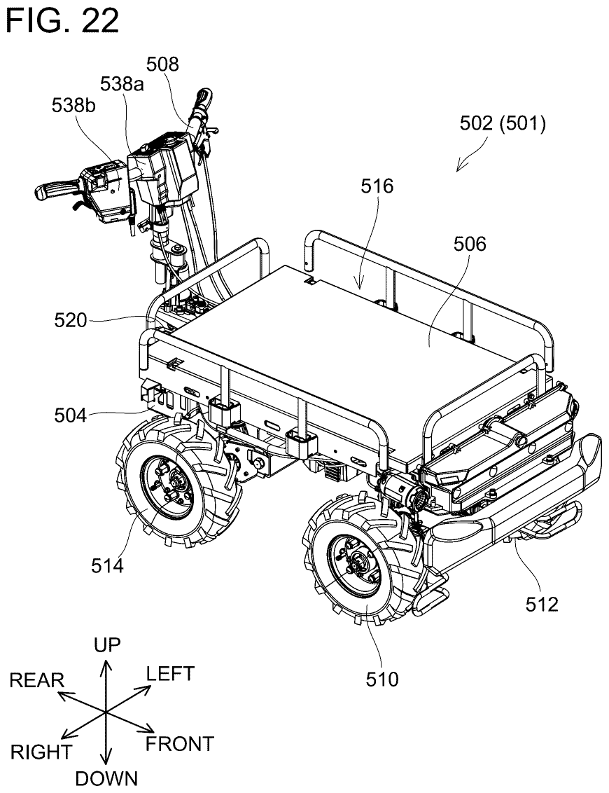

(Second Embodiment: Transport System 501) As illustrated in FIGS. 22 to 25, a transport system 501 comprises a cart 502 and a beacon 582.

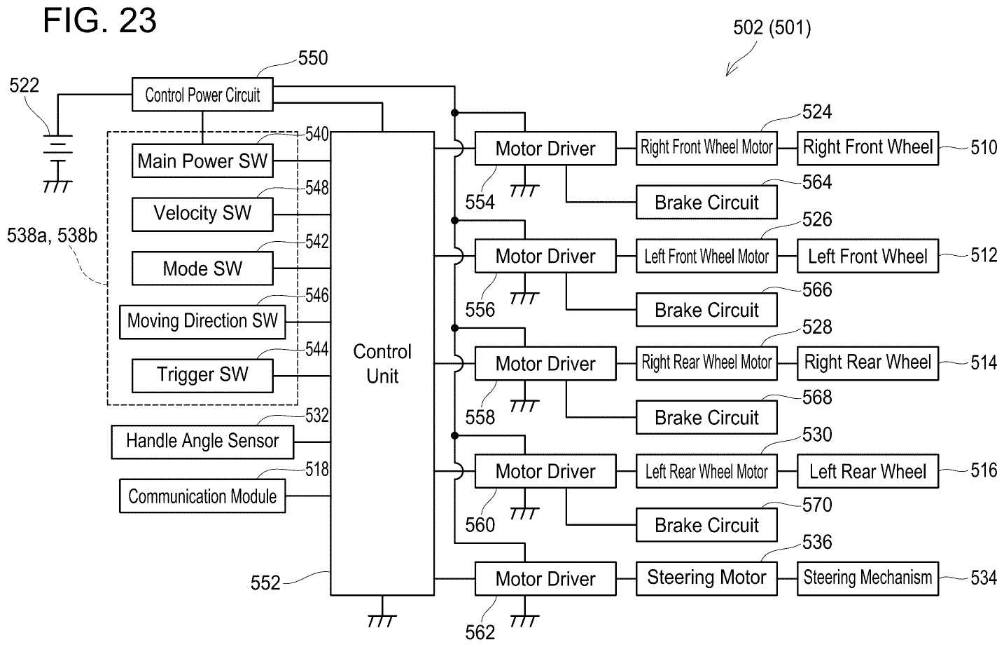

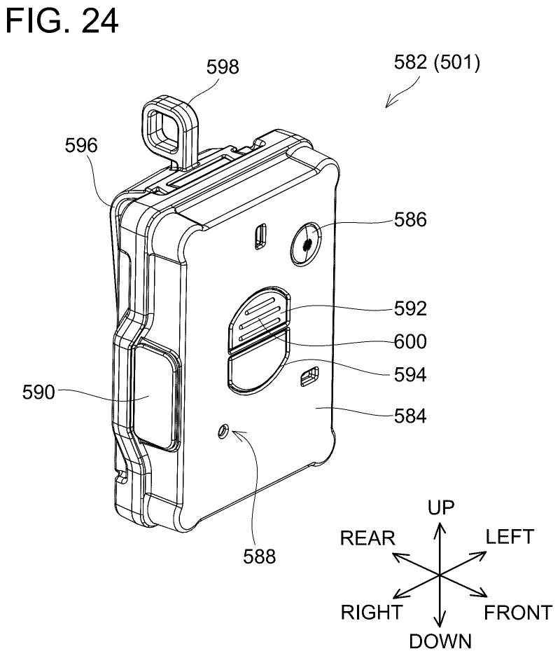

(Configuration of Cart 502) The cart 502 illustrated in FIG. 22 comprises a body 504, a load platform 506, a handle 508, a right-front wheel 510, a left-front wheel 512, a right-rear wheel 514, and a left-rear wheel 516. The load platform 506, the handle 508, the right-front wheel 510, the left-front wheel 512, the right-rear wheel 514, and the left-rear wheel 516 are all supported by the body 504. The cart 502 transports a load carried on the load platform 506. The cart 502 comprises a communication module 518 (see FIG. 23) installed in the body 504. The cart 502 is configured to operate in a manual mode, a following mode, or a parking mode. In the manual mode, the cart 502 moves frontward or rearward according to an operation by the user with the user standing behind the body 504 grasping the handle 508 with his/her hands. In the following mode, the cart 502 executes a following operation of moving to follow the beacon 582 (see FIG. 24) which the user standing in front of the body 504 is carrying. In this case, the cart 502 communicates with the beacon 582 via the communication module 518. In the parking mode, the cart 502 continues to remain stopped without receiving a command from the handle 508 or receiving a command from the beacon 582.

The cart 502 comprises a battery receptacle part 520 arranged in the body 504. The battery receptacle part 520 is configured to have a battery pack 522 (see FIG. 23) detachably attached thereto. The battery pack 522 comprises for example secondary battery cell(s) (not illustrated) such as lithium-ion battery cell(s), and is rechargeable by using a charger (not illustrated). The cart 502 operates on power supplied from the battery pack 522 attached to the battery receptacle part 520.

As illustrated in FIG. 23, the cart 502 comprises a right-front wheel motor 524 configured to drive the right-front wheel 510, a left-front wheel motor 526 configured to drive the left-front wheel 512, a right-rear wheel motor 528 configured to drive the right-rear wheel 514, and a left-rear wheel motor 530 configured to drive the left-rear wheel 516. The right-front wheel motor 524, the left-front wheel motor 526, the right-rear wheel motor 528, and the left-rear wheel motor 530 are for example brushless motors. The right-front wheel motor 524, the left-front wheel motor 526, the right-rear wheel motor 528, and the left-rear wheel motor 530 are supported by the body 504.

As illustrated in FIG. 22, the handle 508 is configured to pivot about a pivot axis extending in the up-down direction relative to the body 504. The user can operate to pivot the handle 508 while the user is grasping the handle 508 with his/her hands. As illustrated in FIG. 23, the cart 502 comprises a handle angle sensor 532 configured to detect a pivoting angle of the handle 508 as a handle angle, a steering mechanism 534 configured to steer the right-front wheel 510 and the left-front wheel 512 as steering wheels, and a steering motor 536 configured to drive the steering mechanism 534. The steering motor 536 is for example a brushless motor. The handle angle sensor 532, the steering mechanism 534, and the steering motor 536 are supported by the body 504.

As illustrated in FIG. 22, switch boxes 538a, 538b are disposed on the handle 508. As illustrated in FIG. 23, the switch boxes 538a, 538b include a main power switch 540, a mode switch 542, a trigger switch 544, a moving direction switch 546, and a velocity switch 548. The main power switch 540 is configured to switch ON/OFF of main power of the cart 502. The mode switch 542 is configured to switch the operation mode of the cart 502 between the manual mode, the following mode, and the parking mode. The trigger switch 544 is configured to switch the cart 502 between moving (ON) and not moving (OFF) and/or to adjust a moving velocity of the cart 502 in the manual mode. The moving direction switch 546 is configured to switch a moving direction of the cart 502 between a forward direction and a reverse direction in the manual mode. The velocity switch 548 is configured to switch the moving velocity of the cart 502 between a low speed state and a high speed state in the manual mode. The user can operate the main power switch 540, the mode switch 542, the trigger switch 544, the moving direction switch 546, and/or the velocity switch 548 while the user is grasping the handle 508 with his/her hands.

The cart 502 comprises a control power circuit 550 and a control device 552. The control power circuit 550 permits to supply power from the battery pack 522 to respective components of the cart 502 (e.g., the control device 552, the right-front wheel motor 524, the left-front wheel motor 526, the right-rear wheel motor 528, the left-rear wheel motor 530, the steering motor 536) when an ON operation is performed on the main power switch 540, and prohibits the supply of power from the battery pack 522 to the respective components of the cart 502 when an OFF operation is performed on the main power switch 540. The control power circuit 550 adjusts the power supplied from the battery pack 522 to a voltage suitable for the respective components of the cart 502 and outputs the same to the respective components of the cart 502. Also, the control device 552 is composed of a CPU, a ROM, and a RAM, for example. The control device 552 controls operation of the cart 502 by the CPU executing process(es) based on information stored in the ROM and RAM. The control device 552 controls operations of the right-front wheel motor 524, the left-front wheel motor 526, the right-rear wheel motor 528, the left-rear wheel motor 530, and the steering motor 536 via motor drivers 554, 556, 558, 560, and 562. Here, the motor drivers 554, 556, 558, and 560 are connected with brake circuits 564, 566, 568, and 570 corresponding to the right-front wheel motor 524, the left-front wheel motor 526, the right-rear wheel motor 528, and the left-rear wheel motor 530. The control device 552 can exert a great braking force on the right-front wheel motor 524, the left-front wheel motor 526, the right-rear wheel motor 528, and the left-rear wheel motor 530 by applying a great current on the brake circuits 564, 566, 568, and 570 while the right-front wheel motor 524, the left-front wheel motor 526, the right-rear wheel motor 528, and the left-rear wheel motor 530 are rotating. The control power circuit 550, the control device 552, the motor drivers 554, 556, 558, 560, and 562, and the brake circuits 564, 566, 568, and 570 are supported by the body 504.

(Configuration of Beacon 582) The beacon 582 illustrated in FIG. 24 is a communication terminal configured to communicate with the cart 502. The beacon 582 comprises a housing 584, a main power switch 586, an initialization switch 588, a pairing switch 590, a following start switch 592, and a following stop switch 594. The housing 584 has a substantially cuboid shape. A rear surface of the housing 584 comprises a clip part 596. The beacon 582 can be put on a user's body (e.g., waist belt) via the clip part 596. Further, a top portion of the housing 584 comprises a ring part 598. The beacon 582 can be held on a holder (e.g., carabiner) worn by the user via the ring part 598. The main power switch 586 is arranged at a position on a front surface of the housing 584 and offset to an upper and left side from a center of the housing 584. The initialization switch 588 is arranged at a position on the front surface of the housing 584 and offset to a lower and right side from the center of the housing 584. The pairing switch 590 is arranged on a right surface of the housing 584. The following start switch 592 and the following stop switch 594 are arranged near and at the center of the front surface of the housing 584. The following start switch 592 is arranged above the following stop switch 594. A surface of the following start switch 592 comprises projections 600, and thereby has bumps and dips. For example, the projections 600 are constituted of a plurality of projected bars extending in the left-right direction. Contrary to this, a surface of the following stop switch 594 is smooth. Due to this, the user can distinguish between the following start switch 592 and the following stop switch 594 by confirming presence/absence of the projections 600. The front-rear direction, the left-right direction, and the up-down direction illustrated in FIG. 24 are different from the front-rear direction, the left-right direction, and the up-down direction which are set with the cart 502 as a reference (see FIG. 22).

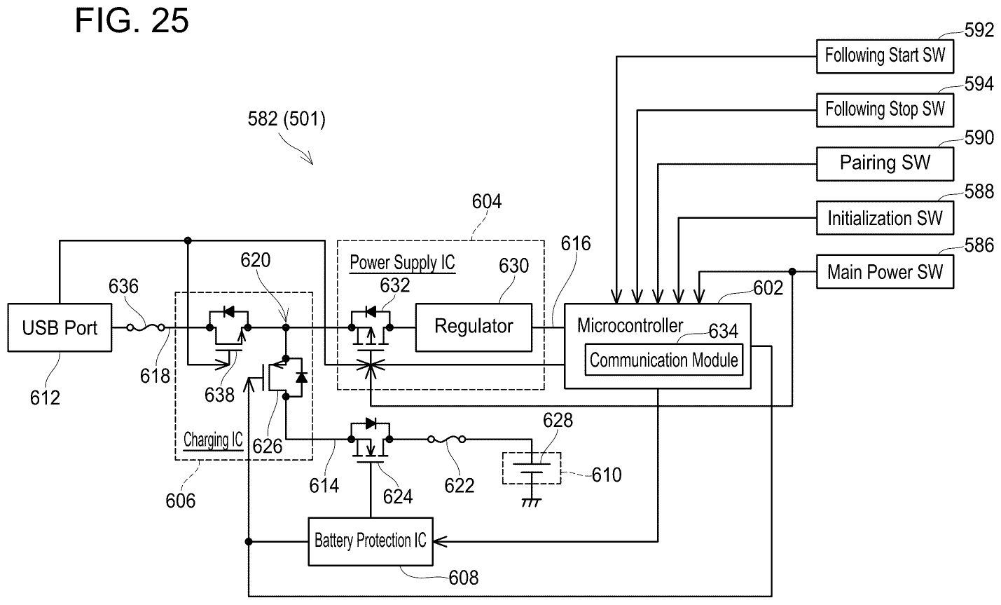

As illustrated in FIG. 25, the beacon 582 comprises a microcontroller 602, a power IC 604, a charging IC 606, a battery protection IC 608, a battery interface 610, and a USB port 612. Although details thereof will be described later, the beacon 582 operates on power supplied from a battery 628 or the USB port 612.

A first power transmission path 614, a second power transmission path 616, and a third power transmission path 618 are arranged between the microcontroller 602, the battery interface 610, and the USB port 612. One end of the first power transmission path 614 is connected to the battery interface 610. One end of the second power transmission path 616 is connected to the microcontroller 602. One end of the third power transmission path 618 is connected to the USB port 612. The other end of the first power transmission path 614, the other end of the second power transmission path 616, and the other end of the third power transmission path 618 are connected to each other at a connection point 620.

On the first power transmission path 614, a fuse 622, a battery protection switch circuit 624, and a first charging switch circuit 626 of the charging IC 606 are arranged in this order from the battery interface 610 toward the connection point 620.

The battery 628 is attached to the battery interface 610. The battery 628 is for example a coin-shaped rechargeable secondary battery (e.g., lithium-ion battery).

The battery protection switch circuit 624 of the present embodiment is a N-channel type MOSFET (Metal-Oxide-Semiconductor Field Effect Transistor), in which a direction from drain to source is a direction from the battery interface 610 to the connection point 620. Due to this, the battery protection switch circuit 624 permits the current to flow from the battery interface 610 toward the connection point 620 when the battery protection switch circuit 624 is ON, and prohibits the current from flowing from the battery interface 610 toward the connection point 620 when the battery protection switch circuit 624 is OFF. Also, a parasitic diode is formed in the battery protection switch circuit 624. This parasitic diode permits the current to flow from the source to the drain in the MOSFET. Due to this, in the battery protection switch circuit 624, no matter whether the battery protection switch circuit 624 is ON/OFF, the current is permitted to flow from the connection point 620 toward the battery interface 610.

The first charging switch circuit 626 of the present embodiment is a P-channel type MOSFET, in which the direction from source to drain is a direction from the connection point 620 toward the battery interface 610. Due to this, the first charging switch circuit 626 permits the current to flow from the connection point 620 toward the battery interface 610 when the first charging switch circuit 626 is ON, and prohibits the current from flowing from the connection point 620 toward the battery interface 610 when the first charging switch circuit 626 is OFF. Also, a parasitic diode is formed in the first charging switch circuit 626. This parasitic diode permits the current to flow from the drain to the source of the MOSFET. Due to this, in the first charging switch circuit 626, no matter whether the first charging switch circuit 626 is ON/OFF, the current is permitted to flow from the battery interface 610 toward the connection point 620.

The battery protection IC 608 is configured to detect whether an abnormality is occurring in the battery 628, and switch ON/OFF of the battery protection switch circuit 624 and/or the first charging switch circuit 626 based on its detection result. For example, when a temperature of the battery 628 is an excessively high temperature (e.g., temperature of 60 degrees or higher), the battery protection IC 608 switches the battery protection switch circuit 624 and the first charging switch circuit 626 OFF. Due to this, charging of the battery 628 and power discharge from the battery 628 are prohibited. Alternatively, when the battery 628 is overly discharging electricity, the battery protection IC 608 switches the battery protection switch circuit 624 OFF. Due to this, power discharge from the battery 628 is prohibited. Alternatively, when the battery 628 is overly charging electricity, the battery protection IC 608 switches the first charging switch circuit 626 OFF. Due to this, charging of the battery 628 is prohibited. Although details will be described later, the battery protection IC 608 is also configured to switch the first charging switch circuit 626 between ON/OFF based on a signal output from the microcontroller 602.

On the second power transmission path 616, a regulator 630 of the power IC 604 and a power switch circuit 632 of the power IC 604 are arranged in this order from the microcontroller 602 toward the connection point 620.

The microcontroller 602 is composed of, a CPU, a ROM, a RAM for example. The microcontroller 602 controls operation of the beacon 582 by the CPU executing process(es) based on information stored in the ROM and RAM, for example. Also, the microcontroller 602 includes a communication module 634 for communicating with the cart 502. The communication module 634 is configured to execute pairing with the communication module 518 (see FIG. 23) of the cart 502 when the pairing switch 590 is operated. By having executed the pairing beforehand, the communication modules 518, 634 can automatically attempt to establish communication with a pairing counterpart when the power is turned on. Here, the communication modules 518, 634 each conform to the UWB (Ultra Wide Band) standard. Due to this, communication conforming to the UWB standard is possible between the cart 502 and the beacon 582.

The regulator 630 adjusts a supplied power to a predefined control voltage (e.g., 3V) when power is supplied from the battery 628 or the USB port 612, and outputs the same to the microcontroller 602. The power as adjusted to the control voltage is outputted to the microcontroller 602, by which the microcontroller 602 can operate.

The power switch circuit 632 of the present embodiment is a P-channel type MOSFET, in which the direction from source to drain is a direction from the connection point 620 toward the microcontroller 602. Due to this, the power switch circuit 632 permits the current to flow from the connection point 620 toward the microcontroller 602 when the power switch circuit 632 is ON, and prohibits the current from flowing from the connection point 620 toward the microcontroller 602 when the power switch circuit 632 is OFF. Also, a parasitic diode is formed in the power switch circuit 632. This parasitic diode permits the current to flow from the drain to the source of the MOSFET. Due to this, in the power switch circuit 632, no matter whether the power switch circuit 632 is ON/OFF, the current is permitted to flow from the microcontroller 602 toward the connection point 620.

On the third power transmission path 618, a fuse 636 and a second charging switch circuit 638 of the charging IC 606 are arranged in this order from the USB port 612 toward the connection point 620.

The second charging switch circuit 638 of the present embodiment is a N-channel type MOSFET (Metal-Oxide-Semiconductor Field Effect Transistor), in which a direction from drain to source is a direction from the USB port 612 to the connection point 620. Due to this, the second charging switch circuit 638 permits the current to flow from the USB port 612 toward the connection point 620 when the second charging switch circuit 638 is ON, and prohibits the current from flowing from the USB port 612 toward the connection point 620 when the second charging switch circuit 638 is OFF. Also, a parasitic diode is formed in the second charging switch circuit 638. This parasitic diode permits the current to flow from the source to the drain in the MOSFET. Due to this, in the second charging switch circuit 638, no matter whether the second charging switch circuit 638 is ON/OFF, the current is permitted to flow from the connection point 620 toward the USB port 612.

Although not illustrated, the USB port 612 is arranged on an outer surface of the housing 584 (see FIG. 24). The USB port 612 is configured to receive a USB cable (not illustrated). Here, when the USB cable connected to an external power supply (e.g., commercial power supply) is connected to the USB port 612, power is supplied from the external power supply via the USB cable and the USB port 612 to the beacon 582. In this case, the beacon 582 can operate on power supplied from the USB port 612. In the present embodiment, a state of the beacon 582 being operating on power supplied from the USB port 612 will be termed “external-power-supply operating state”. When the beacon 582 is in the external-power-supply operating state, the power supplied from the external power supply causes a voltage to be applied on each gate of the second charging switch circuit 638 and the power switch circuit 632, by which each of the second charging switch circuit 638 and the power switch circuit 632 is switched ON. In this case, power is permitted to be supplied from the USB port 612 via the third power transmission path 618 and the second power transmission path 616 to the microcontroller 602, as a result of which the power from the external power supply is supplied to the microcontroller 602. Due to this, the microcontroller 602 is activated, and thus the respective components of the beacon 582 can operate (e.g., the battery protection IC 608).

When the beacon 582 is in the external-power-supply operating state, the microcontroller 602 switches ON/OFF of the first charging switch circuit 626 according to the remaining level of the battery 628 (i.e., voltage of the battery 628). For example, when the remaining level of the battery 628 is low, the microcontroller 602 switches the first charging switch circuit 626 ON. Due to this, the first charging switch circuit 626 and the second charging switch circuit 638 are turned ON, by which power is permitted to be supplied from the USB port 612 via the third power transmission path 618 and the first power transmission path 614 to the battery 628. As a result of this, power from the external power supply is supplied to the battery 628, by which the battery 628 is charged. Then once the remaining level of the battery 628 has restored to a predefined level, the microcontroller 602 switches the first charging switch circuit 626 OFF. Due to this, power is prohibited from being supplied from the USB port 612 via the third power transmission path 618 and the first power transmission path 614 to the battery 628, by which charging of the battery 628 ends. Also, when the beacon 582 is in the external-power-supply operating state, the microcontroller 602 switches ON/OFF of the power of the communication module 634 in response to the main power switch 586 being operated. In this case, with the power switch circuit 632 maintained ON, power from the external power supply continues to be supplied to the microcontroller 602. That is, the “main power” of the beacon 582 herein mentioned is a power supply put into the communication module 634. Also, when the beacon 582 is in the external-power-supply operating state, the microcontroller 602 outputs an power discharge permitting signal to the battery protection IC 608. When the power discharge permitting signal is outputted from the microcontroller 602, the battery protection IC 608 switches the battery protection switch circuit 624 ON. Due to this, the power discharge from the battery 628 is permitted. When the USB cable is removed from the USB port 612 with the battery protection switch circuit 624 ON and thus power supply from the external power supply into the beacon 582 is lost, the beacon 582 starts to operate on power supplied from the battery 628. In the present embodiment, the state of the beacon 582 at this time will be termed “internal-power-supply operating state”.

When the beacon 582 is in the internal-power-supply operating state, in response to the main power switch 586 being operated, ON/OFF of the power switch circuit 632 is switched. Due to this, permission/prohibition of the power supply from the battery 628 to the microcontroller 602 is switched, and accordingly operation/prohibition of the microcontroller 602 is switched. Also, when the beacon 582 is in the internal-power-supply operating state, in response to the initialization switch 588 being operated, the microcontroller 602 outputs an power discharge prohibiting signal to the battery protection IC 608. When the power discharge prohibiting signal is outputted from the microcontroller 602, the battery protection IC 608 switches the battery protection switch circuit 624 OFF. By the battery protection switch circuit 624 being turned OFF, the power discharge from the battery 628 is prohibited, and accordingly operations of the respective components of the beacon 582 (e.g., the microcontroller 602) are stopped. In the present embodiment, the state of the beacon 582 at this time will be termed “power supply shutdown state”. In order to switch the battery protection switch circuit 624 ON and thus permit the power discharge from the battery 628 after the beacon 582 has fallen in the power supply shutdown state, the USB cable needs to be connected to the USB port 612, by which the microcontroller 602 needs to be activated by the power supplied from the external power supply.

(Usage Example of Initialization Switch 588) The beacon 582 may be stored in a storage facility as stock for a long period of time (e.g., more than one year) since production before the beacon 582 is delivered to a user. Also, the user may not use the beacon 582 for a long period of time even after obtaining the beacon 582. During these periods, the beacon 582 may be left without the battery 628 being charged. In this case, because the battery 628 naturally discharges electricity, and the battery 628 may fall into a state of overly discharging electricity. In regards to this phenomenon, the beacon 582 of the present embodiment can suppress the natural power discharge from the battery 628 by operating the initialization switch 588 such that the battery protection switch circuit 624 is turned OFF. Due to this, even if the beacon 582 is left unused for a long period of time without the battery 628 being charged, the battery 628 can be suppressed from falling into the state of overly discharging electricity.

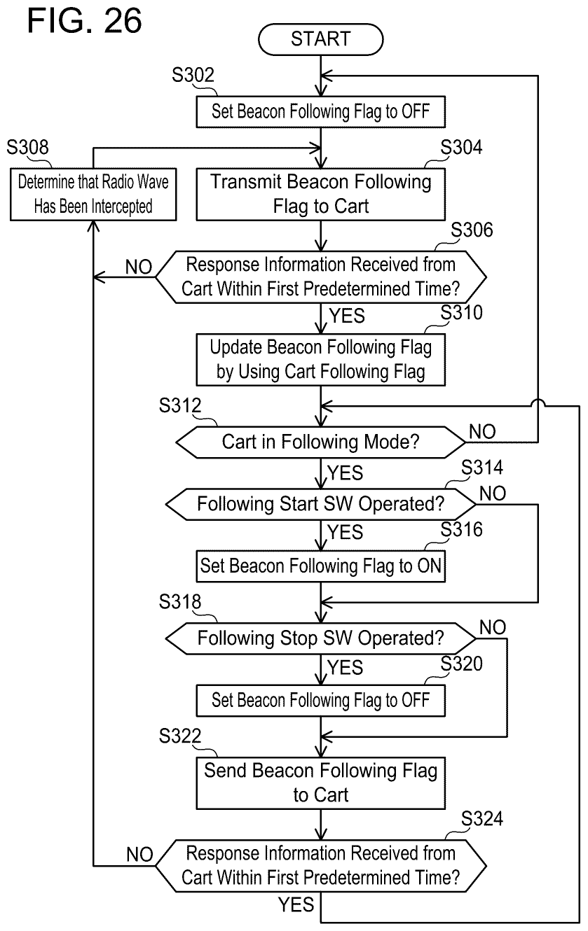

(Process when Main Power of Beacon 582 is ON: FIG. 26) When the main power of the beacon 582 (i.e., power of the communication module 634) is ON, the microcontroller 602 executes processes shown in FIG. 26.

In S302, the microcontroller 602 switches a beacon following flag OFF. The beacon following flag herein mentioned is information stored in the microcontroller 602 and takes a value of either ON or OFF. After S302, the process proceeds to S304.

In S304, the microcontroller 602 sends the beacon following flag to the cart 502. After S304, the process proceeds to S306.

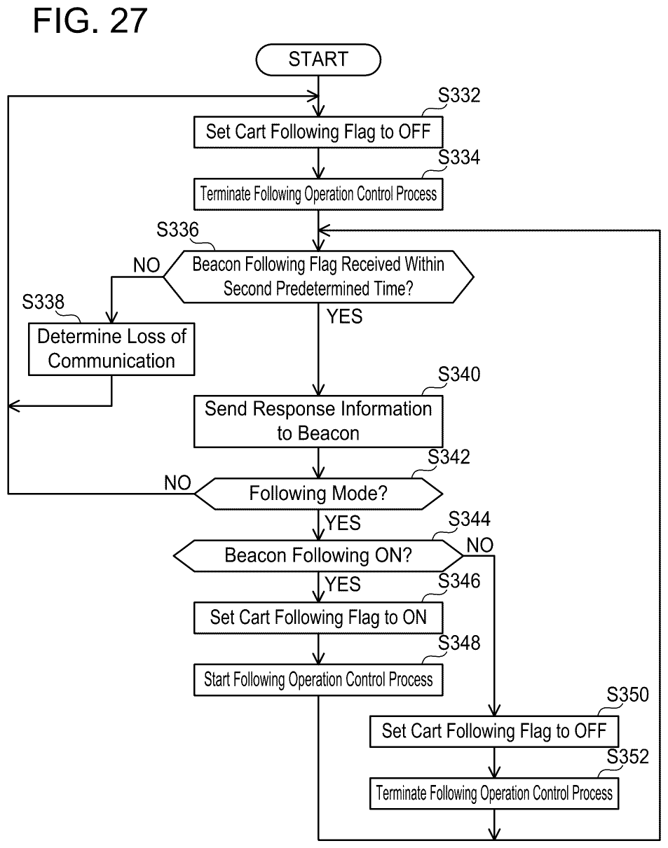

In S306, the microcontroller 602 assesses whether response information from the cart 502 has been received within a first predetermined time (e.g., 50 milliseconds) since S306 has started. When the cart 502 receives the beacon following flag sent by the beacon 582, the cart 502 is configured to send the response information as its response to the beacon 582 (see S340 in FIG. 27 to be described later). The response information includes mode information indicating the operation mode of the cart 502 and a cart following flag. The cart following flag herein mentioned is information stored in the control device 552 of the cart 502 (see FIG. 23), and takes either value of ON or OFF. The cart following flag can be regarded as information indicating whether the following operation is in execution in the cart 502 or not. When the first predetermined time has elapsed since S306 started but the response information is still not received (in case of NO), the process proceeds to S308.

In S308, the microcontroller 602 determines that the radio wave was interrupted between the cart 502 and the beacon 582 and thereby communication between the cart 502 and the beacon 582 was not properly executed. After S308, the process returns to S304.

When the response information is received within the first predetermined time since S306 started (in case of YES to S306), the process proceeds to S310. In S310, the microcontroller 602 updates the beacon following flag by using the cart following flag included in the response information received in S306. Specifically, when the cart following flag received in S306 indicates ON, the microcontroller 602 switches the beacon following flag ON, whereas when the cart following flag received in S306 indicates OFF, the microcontroller 602 switches the beacon following flag OFF. After S310, the process proceeds to S312.

In S312, the microcontroller 602 assesses whether the following mode is selected in the cart 502 based on the mode information included in the response information received in S306. When the following mode is not selected in the cart 502 (in case of NO), the process returns to S302. When the following mode is selected in the cart 502 (in case of YES), the process proceeds to S314.

In S314, the microcontroller 602 assesses whether the following start switch 592 (see FIG. 24) is operated or not. When the following start switch 592 is operated (in case of YES), the process proceeds to S316.

In S316, the microcontroller 602 switches the beacon following flag ON.

When in S314 the following start switch 592 is not operated (in case of NO), or after S316, the process proceeds to S318. In S318, the microcontroller 602 assesses whether the following stop switch 594 (see FIG. 24) is operated or not. When the following stop switch 594 is operated (in case of YES), the process proceeds to S320.

In S320, the microcontroller 602 switches the beacon following flag OFF.

In S322, the microcontroller 602 sends the beacon following flag to the cart 502. After S322, the process proceeds to S324.

In S324, the microcontroller 602 assesses whether the microcontroller 602 has received the response information from the cart 502 within the first predetermined time since S324 started or not. As mentioned above, the response information includes the mode information indicating the operation mode of the cart 502 and the cart following flag. When the first predetermined time has elapsed since S324 started but still the response information is not received (in case of NO), the process proceeds to S308. When the response information is received within the first predetermined time since S324 started (in case of YES), the process returns to S312.

(Process when Main Power of Cart 502 is ON: FIG. 27) When the main power of the cart 502 is ON, the control device 552 of the cart 502 (see FIG. 23) executes processes shown in FIG. 27.

In S332, the control device 552 switches the cart following flag OFF. As mentioned above, the cart following flag is information stored in the control device 552, and takes either value of ON or OFF. After S332, the process proceeds to S334.

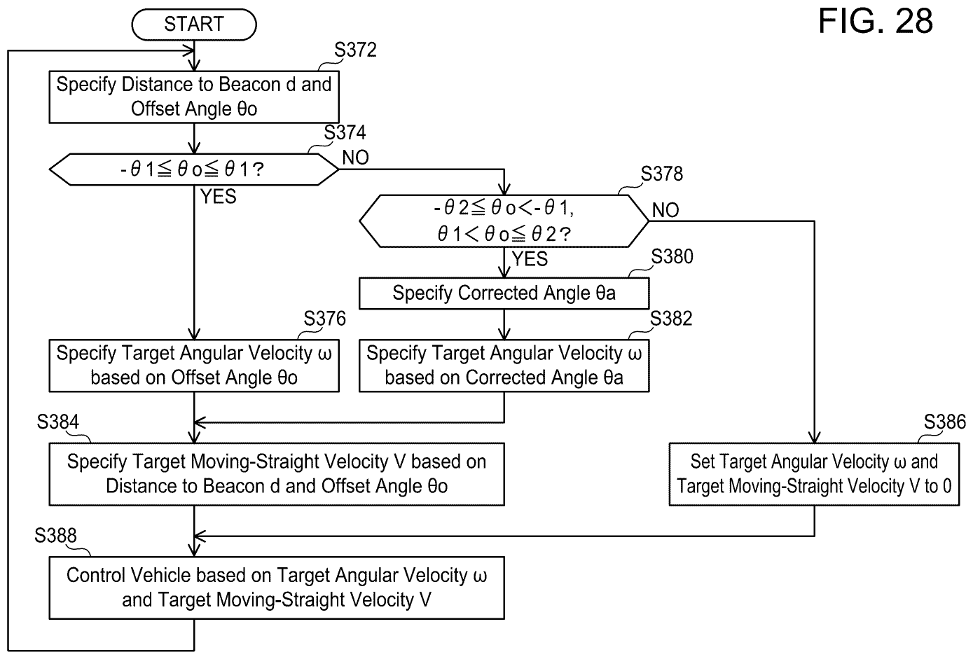

In S334, when the following operation control process (see FIG. 28) is in execution, the control device 552 ends the following operation control process. Although details will be described later, the following operation control process is a process of causing the cart 502 to execute the following operation. When the following operation control process ends and stops being executed, the cart 502 becomes unable to execute the following operation. That is, in S334, the following operation by the cart 502 is stopped. After S334, the process proceeds to S336.

In S336, the control device 552 assesses whether the control device 552 has received the beacon following flag (see S304, S322 in the processes shown in FIG. 26) sent from the beacon 582 within a second predetermined time (e.g., 5 seconds) since S336 started or not. When the second predetermined time has elapsed since S336 started but still the beacon following flag is not received (in case of NO), the process proceeds to S338.

In S338, the control device 552 determines that communication between the cart 502 and the beacon 582 is lost. After S338, the process returns to S332.

When the beacon following flag is received within the second predetermined time since S336 started (in case of YES to S336), the process proceeds to S340. In S340, the response information is sent to the beacon 582. As aforementioned, the response information includes the mode information indicating the operation mode of the cart 502 and the cart following flag. After S340, the process proceeds to S342.

In S342, whether the following mode is selected in the cart 502 or not is assessed. When the following mode is not selected in the cart 502 (in case of NO), the process returns to S332. When the following mode is selected in the cart 502 (in case of YES), the process proceeds to S344.

In S344, the control device 552 assesses whether the beacon following flag received in S336 is ON or not. When the beacon following flag received in S336 is ON (in case of YES), the process proceeds to S346.

In S346, the control device 552 switches the cart following flag ON. After S346, the process proceeds to S348.

In S348, when the following operation control process (see FIG. 28) is not in execution, the control device 552 starts the following operation control process. Although details will be described later, by the following operation control process being executed, the cart 502 becomes able to execute the following operation. After S348, the process returns to S336.

When the beacon following flag received in S336 is OFF (in case of NO to S344), the process proceeds to S350. In S350, the control device 552 switches the cart following flag OFF. After S350, the process proceeds to S352.

In S352, when the following operation control process (see FIG. 28) is in execution, the control device 552 ends the following operation control process. Although details will be described later, when the following operation control process ends and stops being executed, the cart 502 becomes unable to execute the following operation. That is, in S352, the following operation by the cart 502 is stopped. After S352, the process returns to S336.

(Following Start Instruction/Following Stop Instruction from Beacon 582 to Cart 502) According to the processes of FIG. 27, when the beacon following flag indicating ON is sent from the beacon 582 to the cart 502, the following operation by the cart 502 is started. Contrary to this, when the beacon following flag indicating OFF is sent from the beacon 582 to the cart 502, the following operation by the cart 502 is stopped. Due to this, in the present embodiment, the beacon following flag indicating ON is called a following start instruction from the beacon 582 to the cart 502. Also, the beacon following flag indicating OFF is also called a following stop instruction from the beacon 582 to the cart 502.

According to the processes shown in FIG. 26, immediately after the power of the beacon 582 is ON, irrespective of the operation on the beacon 582, the beacon following flag indicating OFF (following stop instruction) is sent to the cart 502 (see S302, S304 in FIG. 26). Accordingly, it is not until the following start switch 592 (see FIG. 24) is operated after the power of the beacon 582 is turned ON that the beacon following flag indicating ON (following start instruction) is sent to the cart 502. Due to this, it is possible to suppress the following operation by the cart 502 from being started at a timing unexpected by the user.

According to the processes shown in FIG. 26, during a period when communication between the cart 502 and the beacon 582 is established and also the cart 502 is in the following mode (while the processes from S312 to S324 are repeatedly executed), operation on the following start switch 592 (see FIG. 24) and operation on the following stop switch 594 (see FIG. 24) are received. Due to this, in the present embodiment, the period when communication between the cart 502 and the beacon 582 is established and also the cart 502 is in the following mode is also called “start-operation receiving period”, and also called “stop-operation receiving period”. In the start-operation receiving period (stop-operation receiving period), once the following start switch 592 (the following stop switch 594) is operated, until the next time the following stop switch 594 (the following start switch 592) is operated, the beacon 582 continuously sends the following start instruction (following stop instruction) to the cart 502. Due to this, a situation where the user has operated the following start switch 592 (the following stop switch 594) but the following operation by the cart 502 is not started (stopped) at all, can be suppressed from occurring.

(Following Operation Control Process: FIG. 28) The following operation control process is a process of controlling the following operation of the cart 502. The following operation control process is executed in the above-mentioned processes of FIG. 27. Specifically, the following operation control process is started when the cart 502 receives the beacon following flag indicating ON (following start instruction) from the beacon 582 (see S344 to S348 in FIG. 27). Then, the following operation control process ends when the cart 502 receives the beacon following flag indicating OFF (the following stop instruction) from the beacon 582 or when communication between the cart 502 and the beacon 582 is lost (see S344, S350, S352, S338, S332, and S334 in FIG. 27).

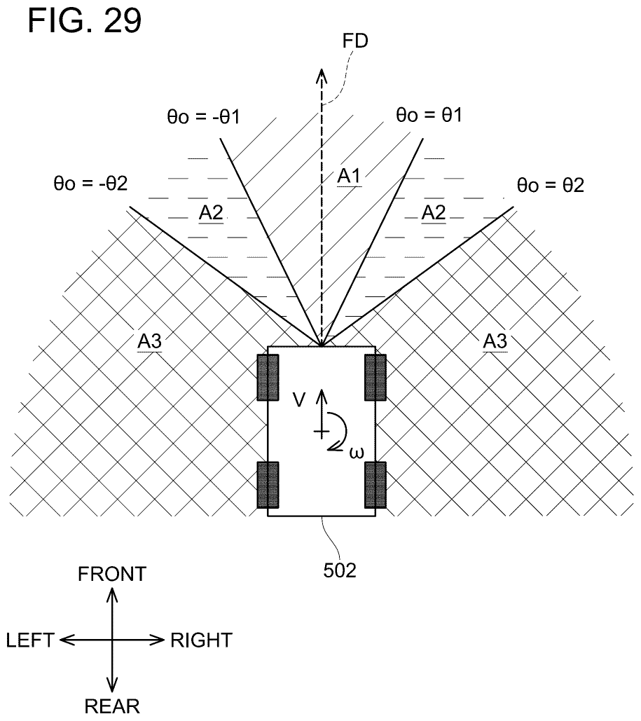

In S372 shown in FIG. 28, the control device 552 specifies a distance d to the beacon 582 and an offset angle θo of the beacon 582 by using positioning technolog (ies) based on the UWB communication such as ToA (Time of Arrival) and/or AoA (Angle of Arrival). As illustrated in FIG. 29, the offset angle θo herein mentioned is an angle of the cart 502 relative to a forward direction FD. In the present embodiment, a direction clockwise in a top view of the cart 502 is defined as a positive direction of the offset angle θo, and a direction counterclockwise in the top view is defined as a negative direction of the offset angle θo. After S372, the process proceeds to S374.

In S374 shown in FIG. 28, the control device 552 assesses whether the offset angle θo specified in S372 is within a predetermined first angular range A1 or not. As illustrated in FIG. 29, the first angular range A1 is an angular range defined as −θ1≤θo≤θ1. A first boundary angle θ1 defining a boundary of the first angular range A1 is for example within a range of 5 degrees to 15 degrees, and is 10 degrees in the present embodiment. When the offset angle θo is within the first angular range A1 (in case of YES), the process proceeds to S376.

In S376 shown in FIG. 28, the control device 552 specifies a target angular velocity ω to be provided to the cart 502 based on the offset angle θo specified in S372. As illustrated in FIG. 29, the target angular velocity ω herein mentioned is an angular velocity about an axis extending in the up-down direction. In the present embodiment, a Formula (7) for deriving the target angular velocity ω from the offset angle θo is defined as follows:

$$ω = ω k * θ o \qquad ( 7 )$$

Here, ωk in the Formula (7) is a predetermined coefficient.

In S374 illustrated in FIG. 28, when the offset angle θo is not within the first angular range A1 (in case of NO), the process proceeds to S378. In S378, the control device 552 assesses whether the offset angle θo specified in S372 is within a predetermined second angular range A2 or not. As illustrated in FIG. 29, the second angular range A2 is adjacent to the first angular range A1 and is an angular range defined as −θ2≤θo<−θ1, θ1<θo≤θ2. A second boundary angle θ2 is within a range of 15 degrees to 30 degrees for example, and is 30 degrees in the present embodiment. When the offset angle θo is within the second angular range A2 (in case of YES), the process proceeds to S380.

In S380 illustrated in FIG. 28, the control device 552 specifies a corrected angle θa based on the offset angle θo specified in S372. When the offset angle θo is a positive value, the corrected angle θa is specified such that θa<θo is satisfied, and when the offset angle θo is a negative value, the corrected angle θa is specified such that θo<θa is satisfied. When the offset angle θo is a positive value, the corrected angle θa in the present embodiment is specified as θa=θ1, and when the offset angle θo is a negative value, the corrected angle θa in the present embodiment is specified as θa=−θ1. After S380, the process proceeds to S382.

In S382, the control device 552 specifies the target angular velocity ω to be provided to the cart 502 based on the corrected angle θa specified in S380. In the present embodiment, by the following Formula (8) in which the offset angle θo is replaced with the corrected angle θa based on the Formula (7) used in S376, the target angular velocity ω is specified.

$$ω = ω k * θ a \qquad ( 8 )$$

By specifying the target angular velocity ω from the Formula (8), as compared to the case where the target angular velocity ω is specified from the above-mentioned Formula (7), the target angular velocity ω with a smaller absolute value can be obtained.

After S376 or after S382, the process proceeds to S384. In S384, the control device 552 specifies a target moving-straight velocity V to be provided to the cart 502 based on the distance d to the beacon 582 and the offset angle θo that were specified in S372. As illustrated in FIG. 29, the target moving-straight velocity V herein mentioned is a velocity of moving straight in the forward direction FD of the cart 502. In the present embodiment, a Formula (9) for deriving the target moving-straight velocity V from the distance d to the beacon 582 and the offset angle θo is defined as follows.

$$V = min ( Vk 1 * d - Vc 1 , Vc 2 - Vk 2 * θ o ) \qquad ( 9 )$$

Here, Vk1, Vk2 in the Formula (9) are predetermined coefficients, and Vc1, Vc2 are constant terms.

In S378 illustrated in FIG. 28, when the offset angle θo is not within the second angular range A2 (in case of NO), i.e., the offset angle θo is within a third angular range A3 (see FIG. 29) defined as θo<−θ2, θ2<θo, the process proceeds to S386. In S386, the control device 552 specifies the target angular velocity ω to be provided to the cart 502 as ω=0, and specifies the target moving-straight velocity V to be provided to the cart 502 as V=0.

After S384 or after S386, the process proceeds to S388. In S388, the control device 552 controls the cart 502 based on the specified target angular velocity ω and the specified target moving-straight velocity V. Specifically, the control device 552 controls the steering motor 536, the right-front wheel motor 524, the left-front wheel motor 526, the right-rear wheel motor 528, and the left-rear wheel motor 530 (see FIG. 23) such that the angular velocity and also the moving-straight velocity of the cart 502 coincide the target angular velocity ω and the target moving-straight velocity V. After S388, the process returns to S372.

In the following operation control process, when the offset angle θo is within the third angular range A3 (see FIG. 29), the control device 552 specifies ω=0, V=0 (see S378 in FIG. 28). In this case, the control device 552 stops the right-front wheel motor 524, the left-front wheel motor 526, the right-rear wheel motor 528, and the left-rear wheel motor 530 and thus stops the cart 502 from moving (following operation). In other words, when the offset angle θo is within the third angular range A3, the cart 502 is prohibited to move (the following operation is prohibited).

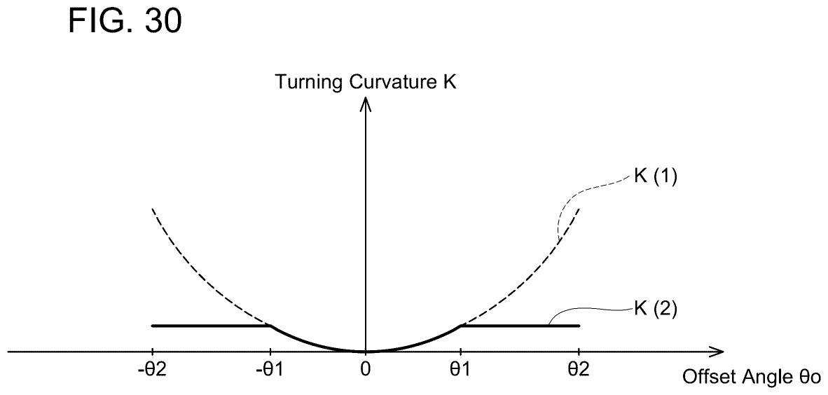

FIG. 30 illustrates a relationship between the offset angle θo and the turning curvature K during the following operation of the cart 502 when the distance d from the cart 502 to the beacon 582 is constant in solid lines. When the offset angle θo is within the first angular range A1 (see FIG. 29), the target angular velocity ω of the cart 502 is specified from the above-described Formula (7) (see S374, S376 in FIG. 28). As a result of this, the greater the offset angle θo, the greater the turning curvature K. In the present embodiment, the turning curvature K when the target angular velocity ω is based on the Formula (7) will be termed “normal turning curvature K(1)”. Also, when the offset angle θo is within the second angular range A2 (see FIG. 29), the target angular velocity ω of the cart 502 is specified from the above-mentioned Formula (8) (see S378, S380, S382 in FIG. 28). As a result of this, the turning curvature K is constant irrespective of the value of the offset angle θo. In the second angular range A2, the turning curvature K when the target angular velocity ω is based on the Formula (8) is smaller than the normal turning curvature K(1) (see broken lines in FIG. 30). In the present embodiment, the turning curvature K when the target angular velocity ω is based on the Formula (8) will be termed “reduced turning curvature K(2)”.

A minimum turning radius of the cart 502 in the following mode is within a range of 4339 mm to 15535 mm for example, and is 7012 mm in the present embodiment. The minimum turning radius of the cart 502 in the following mode can be regarded as a turning radius when the turning curvature K is the reduced turning curvature K(2).

(Processes of Cart 502 in Manual Mode) When the main power of the cart 502 is ON and also the manual mode is selected, the control device 552 illustrated in FIG. 23 controls the cart 502 based on an operation from the user. Specifically, the control device 552 specifies the target angular velocity ω and the target moving-straight velocity V that are to be provided to the cart 502 based on the handle angle detected by the handle angle sensor 532, a pulling degree of the trigger switch 544, and a state of the moving velocity of the cart 502 selected in the velocity switch 548. Then, the control device 552 controls the steering motor 536, the right-front wheel motor 524, the left-front wheel motor 526, the right-rear wheel motor 528, and the left-rear wheel motor 530 such that the angular velocity and the moving-straight velocity of the cart 502 coincide the specified target angular velocity ω and the specified target moving-straight velocity V. Here, the minimum turning radius of the cart 502 in the manual mode is smaller than the minimum turning radius of the cart 502 in the following mode, and is 953 mm in the present embodiment.

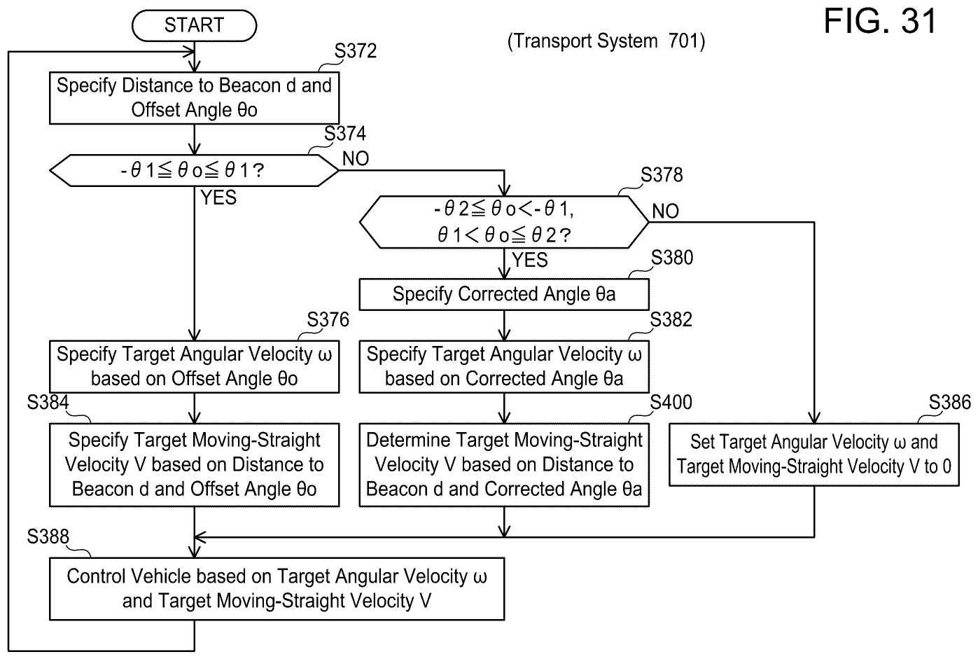

(Third Embodiment: Transport System 701) A transport system 701 has a configuration substantially the same as that of the transport system 501 (see FIGS. 22 to 30) of the second embodiment. The transport system 701 differs from the transport system 501 of the second embodiment only in that the control device 552 of the cart 502 (see FIG. 23) executes processes illustrated in FIG. 31, instead of the processes illustrated in FIG. 28. The processes illustrated in FIG. 31 are the processes illustrated in FIG. 28 with partial modifications. Hereafter, in the processes illustrated in FIG. 31, only modified points from the processes illustrated in FIG. 28 will be described.

In the processes illustrated in FIG. 31, after S382, S400 is executed. In S400, the control device 552 specifies the target moving-straight velocity V to be provided to the cart 502 based on the distance d to the beacon 582 specified in S372 and the corrected angle θa specified in S380. In the present embodiment, by using a following Formula (10) in which the offset angle θo is replaced with the corrected angle θa based on the Formula (9) used in S384, the target moving-straight velocity V is specified.

$$V = min ( Vk 1 * d - Vc 1 , Vc 2 - Vk 2 * θ a ) \qquad ( 10 )$$

After S400, the process proceeds to S388.

(Modifications) The beacon 582 may be replaced with another mobile terminal (e.g., smartphone, tablet).

The prime mover configured to drive the right-front wheel 510, the left-front wheel 512, the right-rear wheel 514, and the left-rear wheel 516 of the cart 502 may be replaced with a prime mover other than the electric motor (e.g., engine comprising an internal combustion mechanism).

The operation of the cart 502 may not comprise the manual mode (or the parking mode). That is, the operation mode of the cart 502 may be switched between the following mode and the parking mode (or the manual mode). Alternatively, the operation mode of the cart 502 may only comprise the following mode. In this case, the cart 502 may not comprise the mode switch 542.

In S372 of FIG. 28, the control device 552 may use a positioning technology other than the positioning technologies based on the UWB communication to specify the distance d to the beacon 582 and the offset angle θo of the beacon 582. For example, a positioning technology based on Bluetooth (registered trademark) communication and a positioning technology based on Wi-Fi (registered trademark) communication may be used.

In the processes of FIG. 28, the control device 552 may specify a target steering angle (swiveling angle of steering wheels relative to the forward direction FD) to be provided to the steering wheels of the cart 502 (the right-front wheel 510 and the left-front wheel 512) instead of specifying the target angular velocity ω to be provided to the cart 502. In this case, in S388 of FIG. 28, the control device 552 may control the steering motor 536, the right-front wheel motor 524, the left-front wheel motor 526, the right-rear wheel motor 528, and the left-rear wheel motor 530 after adjusting the steering angle of the steering wheels to the target steering angle such that the moving-straight velocity of the cart 502 coincides the target moving-straight velocity V.

The cart 502 may not comprise the steering mechanism 534. Even in this case, the cart 502 can perform a turning operation by providing a difference between a rotation speed of the right-front wheel 510 and the right-rear wheel 514 and a rotation speed of the left-front wheel 512 and the left-rear wheel 516. In S388 in FIG. 28 for example, the control device 552 of the cart 502 may control the rotation speeds of the right-front wheel 510, the left-front wheel 512, the right-rear wheel 514, and the left-rear wheel 516 such that the angular velocity and the moving-straight velocity of the cart 502 coincide the target angular velocity ω and the target moving-straight velocity V.

In the processes of FIG. 28, after NO is determined in S374, the process may skip S378, and proceed to S380. That is, even when the offset angle θo is within the third angular range A3, the control device 552 may not stop the cart 502 from moving (following operation) but rather may continue to allow the cart 502 to move.

The beacon 582 may not comprise the following stop switch 594 (see FIG. 24). Even in this case, the user can indirectly stop the following operation by the cart 502 by operating the main power switch 586 (see FIG. 24) and turning the main power of the beacon 582 OFF. This is because communication between the cart 502 and the beacon 582 is lost due to the main power of the beacon 582 being turned OFF, NO is determined to S336 in FIG. 27, and the subsequent processes of S338, S332, and S334 cause the cart 502 to stop the following operation.

A starting instruction send finish condition for finishing sending of the following start instruction from the beacon 582 to the cart 502 may include a condition other than the following stop switch 594 (see FIG. 24) being operated. For example, the starting instruction send finish condition may include a condition that a predetermined time elapses since the following start switch 592 (see FIG. 24) is operated. Alternatively, the starting instruction send finish condition may include a condition that the cart 502 has finished the following operation control process (see FIG. 28).

A stopping instruction send finish condition for finishing sending the following stop instruction from the beacon 582 to the cart 502 may include a condition other than the following start switch 592 (see FIG. 24) being operated. For example, the stopping instruction send finish condition may include a condition that a predetermined time elapses after the following stop switch 594 (see FIG. 24) is operated. Alternatively, the stopping instruction send finish condition may include a condition that the cart 502 has started the following operation control process (see FIG. 28).

The start-operation receiving period (the stop-operation receiving period) may include a period during which the cart 502 is in the manual mode (or the parking mode). Due to this, even in the period during which the cart 502 is in the manual mode (or the parking mode), operation on the following start switch 592 (see FIG. 24) and operation on the following stop switch 594 (see FIG. 24) may be received.

The start-operation receiving period (the stop-operation receiving period) may include a period during which communication between the cart 502 and the beacon 582 is not established. Due to this, even in the period during which communication between the cart 502 and the beacon 582 is not established, operation on the following start switch 592 (see FIG. 24) and operation on the following stop switch 594 (see FIG. 24) may be received.

In the processes of FIG. 26, the process of S302 may be omitted. That is, immediately after the power of the beacon 582 is turned on, or the following mode is not selected in the cart 502 (in case of NO to S312), the beacon following flag may not be switched OFF.

The battery 628 (see FIG. 25) may be a primary battery which is not rechargeable (e.g., may be a manganese lithium battery). In this case, the battery 628 may be attachable and detachable from the beacon 582.

The battery protection switch circuit 624, the power switch circuit 632, the first charging switch circuit 626, and the second charging switch circuit 638 (see FIG. 25) may be respectively mechanical switches.

The beacon 582 may further comprise an operation unit (e.g., switch) for switching the battery protection switch circuit 624 (see FIG. 25) ON. In this case, in order to switch the battery protection switch circuit 624 from OFF to ON, the above-mentioned operation unit may be required to be operated after setting the beacon 582 in the external-power-supply operating state.

(Features in Second and Third Embodiments) In one or more embodiments, the cart 502 may be configured to execute the following operation of autonomously following the beacon 582 (example for a following target). The cart 502 comprises: the body 504; the right-front wheel 510, the left-front wheel 512, the right-rear wheel 514, and the left-rear wheel 516 (example for a wheel) supported by the body 504 and configured to be in contact with a ground; the right-front wheel motor 524, the left-front wheel motor 526, the right-rear wheel motor 528, and the left-rear wheel motor 530 (example for a prime mover) configured to drive the right-front wheel 510, the left-front wheel 512, the right-rear wheel 514, and the left-rear wheel 516; the communication module 518 and the control device 552 (example for an offset angle detector) configured to detect the offset angle θo of the beacon 582 relative to the forward direction FD of the cart 502; and the control device 552. The control device 552 is configured to execute the following operation control process of controlling the following operation of the cart 502. In the following operation control process, when the offset angle θo is within the first angular range A1 including 0 degrees, the control device 552 adjusts the turning curvature K(example for a turning degree) of the cart 502 during the following operation to the normal turning curvature K(1) corresponding to the offset angle θo, and when the offset angle θo is within the second angular range A2 adjacent to the first angular range A1, the control device 552 adjusts the turning curvature K of the cart 502 during the following operation to the reduced turning curvature K(2) which is reduced from the normal turning curvature K(1) corresponding to the offset angle θo.

When an absolute value of the offset angle θo is greater, a turning angle required to direct the forward direction FD of the cart 502 toward the beacon 582 is greater, and due to this, increasing the turning curvature K of the cart 502 may be considered. However, if the turning curvature K of the cart 502 is excessively large, an inner wheel difference of the cart 502 may be excessively enlarged. As a result, the cart 502 may collide with an obstacle, as a result of which the following operation of the cart 502 may not smoothly proceed. According to the above configuration, when the offset angle θo is within the second angular range A2 (that is, the absolute value of the offset angle θo is relatively large), the turning curvature K of the cart 502 is reduced than in normal times. Due to this, the turning curvature K of the cart 502 can be suppressed from becoming excessively large, by which the inner wheel difference of the cart 502 can be suppressed from being excessively enlarged. Due to this, the cart 502 can be suppressed from contacting an obstacle, by which the following operation of the cart 502 can be smoothly proceeded.

In one or more embodiments, the turning degree includes the turning curvature K of the cart 502. In the following operation control process, when the offset angle θo is within the first angular range A1, the control device 552 adjusts the turning curvature K of the cart 502 during the following operation to the normal turning curvature K(1) corresponding to the offset angle θo, and when the offset angle θo is within the second angular range A2, the control device 552 adjusts the turning curvature K of the cart 502 during the following operation to the reduced turning curvature K(2) which is reduced from the normal turning curvature K(1) corresponding to the offset angle θo.

According to the above configuration, when the offset angle θo is within the second angular range A2 (i.e., the absolute value of the offset angle θo is relatively large), the turning curvature K of the cart 502 can be reduced than in normal times. Due to this, the turning curvature K of the cart 502 can be suppressed from being excessively increased, by which the inner wheel difference of the cart 502 can be suppressed from being excessively enlarged. Due to this, since the cart 502 can be suppressed from contacting an obstacle, the following operation of the cart 502 can be smoothly proceeded.

In one or more embodiments, the cart 502 is configured to switch between the following mode in which execution of the following operation is permitted and the manual mode in which the execution of the following operation is prohibited and the cart 502 moves based on an operation from a user. The minimum turning radius of the cart 502 in the following mode is greater than the minimum turning radius of the cart 502 in the manual mode.

When the cart 502 has a smaller turning radius, the inner wheel difference of the cart 502 is enlarged. Due to this, in the following mode in which the operation by the user does not intervene, the cart 502 may contact an obstacle if the turning radius of the cart 502 becomes small. In the meantime, in the manual mode in which the operation by the user intervenes, even when the turning radius of the cart 502 becomes small to a certain degree, the possibility of the cart 502 contacting an obstacle is probably low. Rather, if the turning radius of the cart 502 cannot be made small in the manual mode, maneuverability of the cart 502 may be decreased. According to the above configuration, the minimum turning radius of the cart 502 in the following mode is greater than the minimum turning radius of the cart 502 in the manual mode. As a result, the turning radius of the cart 502 can be suppressed from being made small in the following mode, and the turning radius can be permitted to be small in the manual mode. Due to this, the cart 502 can be suppressed from contacting an obstacle without imparting the maneuverability of the cart 502 in the manual mode.

In one or more embodiments, in the following operation control process, when the offset angle θo is within the third angular range A3 excluding the first angular range A1 and the second angular range A2, the control device 552 stops the right-front wheel motor 524, the left-front wheel motor 526, the right-rear wheel motor 528, and the left-rear wheel motor 530 to stop the following operation by the cart 502.

When an absolute value of the offset angle θo is greater and thus a turning angle required to direct the forward direction FD of the cart 502 to the beacon 582 is greater, the cart 502 would need to be turned greatly. However, if the cart 502 is turned greatly, the cart 502 may contact an obstacle, by which the following operation of the cart 502 may not proceed smoothly. According to the above configuration, when the offset angle θo is within the third angular range A3 (i.e., the absolute value of the offset angle θo is relatively large), the following operation by the cart 502 is stopped. Due to this, the cart 502 can be suppressed from turning greatly. As a result, the cart 502 can be suppressed from contacting the obstacle, the following operation by the cart 502 can be smoothly proceeded.

In one or more embodiments, the cart 502 is configured to execute a following operation of autonomously following the beacon 582 (example for a following target). The cart 502 comprises: the body 504; the right-front wheel 510, the left-front wheel 512, the right-rear wheel 514, and the left-rear wheel 516 (example for a wheel) supported by the body 504 and configured to be in contact with a ground; the right-front wheel motor 524, the left-front wheel motor 526, the right-rear wheel motor 528, and the left-rear wheel motor 530 (example for a prime mover) configured to drive the right-front wheel 510, the left-front wheel 512, the right-rear wheel 514, and the left-rear wheel 516; the communication module 518 and the control device 552 (example for an offset angle detector) configured to detect the offset angle θo of the beacon 582 relative to the forward direction FD of the cart 502; and the control device 552. The control device 552 is configured to operate the right-front wheel motor 524, the left-front wheel motor 526, the right-rear wheel motor 528, and the left-rear wheel motor 530 to cause the cart 502 to execute the following operation when the offset angle θo is within the first angular range A1 and the second angular range A2 (example for an operation angular range) including 0 degrees, and the control device 552 is configured to stop the right-front wheel motor 524, the left-front wheel motor 526, the right-rear wheel motor 528, and the left-rear wheel motor 530 to stop the following operation by the cart 502 when the offset angle θo is within the third angular range A3 (example for a stop angular range) adjacent to the first angular range A1 and the second angular range A2.

When an absolute value of the offset angle θo is greater and thus a turning angle required to direct the forward direction FD of the cart 502 toward the beacon 582 is greater, the cart 502 would need to be turned greatly. However, if the cart 502 is turned greatly, the cart 502 may contact an obstacle, by which the following operation of the cart 502 may not proceed smoothly. According to the above configuration, when the offset angle θo is within the first angular range A1 and the second angular range A2 (i.e., the absolute value of the offset angle θo is relatively small), the following operation by the cart 502 is executed. When the offset angle θo is within the third angular range A3 (i.e., the absolute value of the offset angle θo is relatively large), the following operation by the cart 502 is stopped. Due to this, the cart 502 can be suppressed from turning greatly. As a result, the cart 502 can be suppressed from contacting the obstacle, the following operation by the cart 502 can be smoothly proceeded.

In one or more embodiments, the transport system 501, 701 comprises: the cart 502; and the beacon 582 (example for a communication terminal) configured to communicate with the cart 502. The cart 502 is configured to execute a following operation of following the beacon 582 when the beacon 582 is moving. The beacon 582 comprises: the main power switch 586 (example for a first operation part); and the following start switch 592 (example for a second operation part) located at a position different from the main power switch 586. When the main power switch 586 is operated, the beacon 582 switches ON/OFF of a power of the beacon 582. When the following start switch 592 is operated during the predetermined start-operation receiving period (period during which the processes from S312 to S324 in FIG. 26 are repeatedly executed) with the power on, the beacon 582 sends the following start instruction which instructs to start the following operation (beacon following flag indicating ON) to the cart 502.

According to the above configuration, the beacon 582 includes the following start switch 592 for causing the cart 502 to start the following operation at the position different from the main power switch 586. Even if the main power switch 586 is operated without user's intention, unless the following start switch 592 is operated thereafter, the following operation by the cart 502 is not started. Due to this, the following operation by the cart 502 can be suppressed from being started without user's intension.

In one or more embodiments, the beacon 582 may further comprise the following stop switch 594 (example for a third operation part) disposed at a position different from those of the main power switch 586 and the following start switch 592. When the following stop switch 594 is operated during the predetermined stop operation receiving period (period during which the processes from S312 to S324 in FIG. 26 are repeatedly executed) with the power on, the beacon 582 sends the following stop instruction which instructs to stop the following operation (the beacon following flag indicating OFF) to the cart 502.

It is also conceivable to provide the beacon 582 with a switching operation part configured to receive switching between starting and stopping of the following operation. In this configuration however, when the user operates the switching operation part, whether the beacon 582 instructs the cart 502 to start or stop the following operation may be unclear for the user. According to the above configuration, the operation part (following start switch 592) for receiving the start of the following operation and the operation part (following stop switch 594) for receiving the stop of the following operation are disposed separate from each other. Due to this, when the user operates the following start switch 592/the following stop switch 594, whether the beacon 582 instructs the cart 502 to start/stop the following operation is clarified for the user.

In one or more embodiments, when the following stop switch 594 is operated during the stop operation receiving period with the power on, the beacon 582 continuously sends the following stop instruction to the cart 502 until the predetermined send finish condition is satisfied.

For example, if communication connection is not good between the cart 502 and the beacon 582, the following stop instruction sent from the beacon 582 may not be received at the cart 502. If the beacon 582 stops sending the following stop instruction despite the cart 502 has not received the following stop instruction, the following operation by the cart 502 would not be stopped, and thus would undesirably continue thereafter. In this configuration, a situation in which the user has operated the following stop switch 594 but the following operation by the cart 502 is not stopped at all may happen. According to the above configuration, after the following stop switch 594 is operated, the beacon 582 continuously sends the following stop instruction until the send finish condition is satisfied. Due to this, the situation in which the user has operated the following stop switch 594 but the following operation by the cart 502 is not stopped at all can be suppressed.

In one or more embodiments, the send finish condition includes the first send finish condition that the following start switch 592 is operated.

According to the above configuration, the beacon 582 continuously sends the following stop instruction from when the following stop switch 594 is operated until the following start switch 592 is operated next. Due to this, the situation in which the user has operated the following stop switch 594 but the following operation by the cart 502 is not stopped at all can be suppressed.

In one or more embodiments, the cart 502 is configured to switch between the following mode in which execution of the following operation is permitted and the manual mode in which the execution of the following operation is prohibited and the cart 502 moves based on an operation from a user. The start-operation receiving period is at least a period during which the cart 502 is in the following mode.

If a period during which the cart 502 is in the manual mode is the start-operation receiving period, when the following start switch 592 is operated during the manual mode, the following operation by the cart 502 may undesirably start at the timing when the cart 502 is switched to the following mode thereafter. Due to this, the following operation by the cart 502 may undesirably start a while late after the user has operated the following start switch 592. This means that the following operation by the cart 502 starts at an unexpected timing for the user. According to the above configuration, the start-operation receiving period is at least a period during which the cart 502 is in the following mode. Due to this, even if the following start switch 592 is operated during the manual mode, since that operation is not accepted, the following operation by the cart 502 is not to start thereafter. Due to this, the following operation by the cart 502 can be suppressed from being started at an unexpected timing for the user.

In one or more embodiments, the start-operation receiving period is at least a period during which communication between the cart 502 and the beacon 582 is established.

If a period during which the communication between the cart 502 and the beacon 582 is lost is the start-operation receiving period, when the following start switch 592 is operated during such period, the following operation by the cart 502 may undesirably start at a timing when the communication is established thereafter. Due to this, the following operation by the cart 502 may undesirably start a while late after the user has operated the following start switch 592. This means that the following operation by the cart 502 starts at an unexpected timing for the user. According to the above configuration, the start-operation receiving period is at least a period during which the communication between the cart 502 and the beacon 582 is established. Due to this, even if the following start switch 592 is operated during the period when the communication between the cart 502 and the beacon 582 is lost, since that operation is not accepted, the following operation by the cart 502 is not to start thereafter. Due to this, the following operation by the cart 502 can be suppressed from being started at an unexpected timing for the user.

In one or more embodiments, the beacon 582 sends the following stop instruction which instructs the cart 502 to stop the following operation to the cart 502 immediately after the power is turned on.

According to the above configuration, the following operation by the cart 502 is stopped immediately after the power of the beacon 582 is turned on. Due to this, for the first time the following start switch 592 is operated after the power of the beacon 582 is turned on, the following operation by the cart 502 is started. Due to this, the following operation by the cart 502 can be suppressed from being started without a user's intention.

In one or more embodiments, the beacon 582 (example for electric apparatus) comprises: the microcontroller 602; the battery interface 610 configured to be electrically connected to the battery 628; the power switch circuit 632 (example for a first switch circuit) configured to permit power supply to the microcontroller 602 when the power switch circuit 632 is ON and configured to prohibit power supply to the microcontroller 602 when the power switch circuit 632 is OFF; and the battery protection switch circuit 624 (example for a second switch circuit) configured to permit power discharge from the battery 628 when the battery protection switch circuit 624 is ON and prohibit power discharge from the battery 628 when the battery protection switch circuit 624 is OFF.

When the beacon 582 is left unused for a long period of time with the battery 628 attached to the battery interface 610, a remaining level of the battery 628 may decrease due to natural power discharge. According to the above configuration, the battery protection switch circuit 624 configured to switch between permission/prohibition on the power discharge from the battery 628 is provided separately from the power switch circuit 632 configured to switch permission/prohibition on the power supply to the microcontroller 602 (i.e., ON/OFF of power). In this configuration, by having the battery protection switch circuit 624 OFF, the natural power discharge from the battery 628 can be suppressed. Due to this, by having the battery protection switch circuit 624 OFF when the beacon 582 is left unused for a long period of time, the decrease in the remaining level of the battery 628 can be suppressed. In one or more embodiments, the battery protection switch circuit 624 and the power switch circuit 632 are arranged in series on the power supply path from the battery interface 610 to the microcontroller 602 (i.e., the first power transmission path 614, the connection point 620, and the second power transmission path 616).

According to the above configuration, by having the battery protection switch circuit 624 OFF, irrespective of the ON/OFF state of the power switch circuit 632, the power supply to the microcontroller 602 can be prohibited.

In one or more embodiments, the power switch circuit 632 is a MOSFET (example for electrical switch). The battery protection switch circuit 624 is a MOSFET (example for electrical switch).

According to the above configuration, as compared to when the power switch circuit 632 (battery protection switch circuit 624) is for example a mechanical switch, the power switch circuit 632 (battery protection switch circuit 624) can be made smaller.

In one or more embodiments, the beacon 582 further comprises the USB port 612 configured to receive a USB cable. The battery protection switch circuit 624 is switched from OFF to ON when the beacon 582 is supplied with power from the USB cable via the USB port 612.

According to the above configuration, with a relatively simple operation of connecting the USB cable to the USB port 612, the battery protection switch circuit 624 can be switched from OFF to ON.

In one or more embodiments, the battery 628 is a rechargeable secondary battery.

When the battery 628 is a secondary battery, the battery 628 may be sometimes configured difficult to be removed from the beacon 582. Due to this, the battery 628 is stored in the state attached to the beacon 582, and natural power discharge from the battery 628 may occur while the beacon 582 is stored. In order to address this situation, according to the above configuration, by having the battery protection switch circuit 624 OFF while the beacon 582 is stored, the natural power discharge from the battery 628 can be suppressed.

What is claimed is:

1. A cart comprising:
a body unit;
a ground contact unit supported by the body unit and configured to be in contact with a ground;
a prime mover configured to drive the ground contact unit;
a first UWB anchor including a first antenna and a second antenna different from the first antenna and configured to receive a beacon signal from a UWB tag configured to be carried by a user;
a second UWB anchor a position of which is different from that of the first UWB anchor in a front-rear direction and configured to receive the beacon signal from the UWB tag; and
a control device configured to execute a following operation of causing the cart to follow the UWB tag by driving the prime mover,
wherein the control device is configured to calculate a first distance which is a distance between the first UWB anchor and the UWB tag and a first tag angle which is an angle of the UWB tag relative to the first UWB anchor by using the beacon signal received by the first antenna and the beacon signal received by the second antenna.

2. The cart according to claim 1, wherein the control device is configured to calculate a second distance which is a distance between the second UWB anchor and the UWB tag by using the beacon signal received by the second UWB anchor, and
the control device is configured to determine whether the UWB tag is located in a first area or a second area different from the first area by using the first distance and the second distance.

3. The cart according to claim 2, wherein the first UWB anchor is located frontward of the second UWB anchor,
the first antenna and the second antenna are aligned in a left-right direction,
a midpoint between the first antenna and the second antenna in the left-right direction matches a center of the second UWB anchor in the left-right direction,
when a second tag angle which is an angle between a first virtual line connecting the first UWB anchor and the UWB tag and a second virtual line connecting the first UWB anchor and the second UWB anchor is an obtuse angle, the control device determines that the UWB tag is located in the first area, and
when the second tag angle is 90 degrees or an acute angle, the control device determines that the UWB tag is located in the second area.

4. The cart according to claim 2, wherein the first area is a following operation permitted area in which the following operation is permitted, and
the second area is a following operation prohibited area in which the following operation is prohibited.

5. The cart according to claim 4, wherein when the control device determines that the UWB tag is located in the following operation permitted area, the control device calculates a target velocity and a target angular velocity by using the first distance and the first tag angle to control the prime mover.

6. The cart according to claim 5, wherein when the control device determines that the UWB tag has moved from the following operation permitted area to the following operation prohibited area, the control device stops the prime mover, and
when the control device determines that the UWB tag has moved from the following operation prohibited area to the following operation permitted area, the control device drives the prime mover.

7. The cart according to claim 1, wherein the first UWB anchor has a higher receiving sensitivity for signals arriving from a front side than for signals arriving from a rear side.

8. The cart according to claim 1, further comprising a load platform supported by the body unit,
wherein one of the first UWB anchor and the second UWB anchor is a front UWB anchor located frontward of the load platform.

9. The cart according to claim 8, wherein the other of the first UWB anchor and the second UWB anchor is a rear UWB anchor located rearward of the load platform, and
the rear UWB anchor is located above the front UWB anchor and the load platform.

10. The cart according to claim 9, further comprising a handle including a grip configured to be grasped by the user,
wherein the handle is located above the load platform, and
the rear UWB anchor is disposed in or on the handle.

11. The cart according to claim 3, wherein the first area is a following operation permitted area in which the following operation is permitted,
the second area is a following operation prohibited area in which the following operation is prohibited,
when the control device determines that the UWB tag is located in the following operation permitted area, the control device calculates a target velocity and a target angular velocity by using the first distance and the first tag angle to control the prime mover,
when the control device determines that the UWB tag has moved from the following operation permitted area to the following operation prohibited area, the control device stops the prime mover,
when the control device determines that the UWB tag has moved from the following operation prohibited area to the following operation permitted area, the control device drives the prime mover,
the first UWB anchor has a higher receiving sensitivity for signals arriving from a front side than for signals arriving from a rear side,
the cart further comprises a load platform supported by the body unit,
one of the first UWB anchor and the second UWB anchor is a front UWB anchor located frontward of the load platform,
the other of the first UWB anchor and the second UWB anchor is a rear UWB anchor located rearward of the load platform,
the rear UWB anchor is located above the front UWB anchor and the load platform,
the cart further comprises a handle including a grip configured to be grasped by the user,
the handle is located above the load platform, and
the rear UWB anchor is disposed in or on the handle.
